(19) United States
(12) Patent Application Publication
(10) Pub. No.: US 2026/0244796 A1
(43) Pub. Date: Aug. 20, 2026

(54) SYSTEMS AND METHODS FOR COMPONENT IDENTIFICATION

(71) Applicant: PwC Product Sales LLC, New York, NY (US)

(72) Inventors: George Rankin SCHURMAN, III, Spring, TX (US); Kevin Barclay SMITH, River Forest, IL (US); Jamir R. WALKER, Lilburn, GA (US); Joshua James YEE, Chicago, IL (US)

(73) Assignee: PwC Product Sales LLC, New York, NY (US)

(21) Appl. No.: 19/059,063

(22) Filed: Feb. 20, 2025

(51) Int. Cl. G06F 30/12; G06F 111/10

(52) U.S. Cl. CPC G06F 30/12; G06F 2111/10

(57) ABSTRACT

A method for identifying components for use in a manufacturing process is provided. The method comprises receiving a plurality of CAD files of components; receiving a user input specifying a component related to the manufacturing process; and generating a similarity metric quantifying a similarity between a model of a reference component and a model of a specified component. The similarity is based on at least one first attribute of the reference component model and on at least one second attribute of the specified component model. The at least one first attribute and the at least one second attribute are selected from a group consisting of: a set of model-generating instructions, a model volume, and a set of model surface types. The method comprises identifying, based on the similarity metric, one or more reference components for use in the manufacturing process.

### FIELD

The present disclosure relates generally to computer systems for management of manufacturing components, and specifically to computer systems for identifying manufacturing components.

### BACKGROUND

Over time, the number of unique parts, components, or assemblies within a system or product line of manufacturing organization may increase. This may be a result of a number of factors, for example inconsistent use of standards or design processes, or the introduction of incremental variations to meet specific customer needs or market demands. Component proliferation may be a particular issue in well-regulated fields such as the aerospace industry in which custom parts are necessary to meet stringent design requirements while satisfying regulatory and/or certification processes. Excessive component proliferation in such settings can lead to several inefficiencies, including increased production costs, supply chain complexity, inventory management challenges, and longer lead times. Moreover, component proliferation can make maintenance and quality control more difficult, as well as increase the time an organization spends on component sourcing.

In some instances, proliferation may result from dispersal of component data throughout various systems within a manufacturing organization, causing component data to be incomplete or inconsistent. Without an adequate means to search for and identify components that are similar to an existing or proposed component, further unintended and unnecessary proliferation may take place. This may impact engineers creating new components or assemblies and/or procurement coordinators sourcing sets of components, and may lead to inefficient use of time and computational resources. For example, without the ability or time to check whether a part sufficiently similar to a proposed component already exists within an organization's component library, an engineer may instead generate a new part, compounding the issue of proliferation for organizations with a large number of components.

### SUMMARY

As described above, excessive component proliferation can lead to several inefficiencies, including increased production costs, increased supply chain complexity, increased inventory management challenges, inefficient use of human and computational resources, and longer lead times for manufacturing. Moreover, component proliferation can make maintenance and quality control more difficult, as well as increase the time an organization spends on component sourcing. Accordingly, there is a need for improved systems and methods to respond to excessive component proliferation, and to prevent or mitigate further excessive component proliferation. Disclosed herein are systems and methods that may address the above-identified need.

Disclosed herein are computer-implemented systems and methods for identifying components for use in a manufacturing process based on similarity to a specified component, to assist organizations in reducing component proliferation. A user may provide an exemplary system an input specifying a particular component to prompt the system to determine whether similar components already exist within a database containing component CAD files. An exemplary component identification system may locate a CAD file of both the specified component and a reference component, which may be located in a CAD file database, and extract attributes corresponding to the CAD model stored within each CAD file. For example, the system may extract the instructions used to generate each model, the volume of each model, and/or the types of surfaces making up each model. The system may generate a similarity metric quantifying the geometric similarity between the specified component model and reference component model based on the degree of similarity between model-generating instructions, model volume, and/or model surface types of each component. An exemplary component identification system may additionally locate component parameters, for example the identification number, name, description, categories, characteristic dimensions, suppliers, storage locations, materials, and/or certifications. The user input, parameters, and computed similarity metric may be used to generate a prompt for a generative AI language model that may identify one or more reference components for use in the manufacturing process based on similarity to the specified component. An exemplary system may then import a CAD model of the one or more identified reference components into an existing CAD model, display the components on a graphical user interface, delete the components from a component database, and/or designate the similarity of the components within the component database.

An exemplary system may receive an input from a user specifying a component related to a manufacturing process for the purpose of locating reference components with a sufficient degree of similarity. The input may take the form of an indication of a CAD model of a specified component provided, for example, by a plugin module of the system used to interface to an external CAD program. The input may additionally or alternatively take the form of a textual user input entered, for example, into a chatbot of the system powered by a generative AI language model. This specification of a component may allow the system to extract a specified component CAD file from the CAD file database and/or to receive a CAD file corresponding to the specified component from the CAD program plugin module. Attributes such as model-generating instructions, model volume, and/or model surface types, extracted from the text-based CAD file of the specified component, and/or parameters of the specified component and/or reference components extracted from a component parameter database may be used by the system to select one or more reference components for comparison to the specified component. For example, the one or more reference components may be selected based on category and/or description parameters that are similar to those of the specified component. CAD files corresponding to these reference components may be extracted from the CAD file database and attributes of reference component CAD models such as model-generating instructions, model volume, and/or model surface types may be extracted from text-based CAD files of the reference components.

Attributes of a reference component CAD model and specified component CAD model may form the basis for generating a similarity metric quantifying a similarity between the reference component CAD model and the specified component CAD model. For example, the model-generating instructions of each CAD model may be compared to generate an instruction similarity, for example based on the number of times each instruction type cites each other instruction type present within the CAD files of the reference component and specified component. Additionally or alternatively, the volumes of each CAD model may be compared to generate a volume similarity, and/or one or more surfaces of each CAD model may be compared to generate a surface or shape similarity. Each similarity may be normalized based on, for example, a magnitude of a tensor representing instruction relationships contained within the reference and/or specified component CAD files, a volume of the reference component and/or specified component CAD models, and/or the number of surfaces of a surface type present in the reference component and/or specified component CAD models.

Further, each similarity may be summed to compute a similarity metric representing the similarity between the reference component and specified component CAD models. To compute the sum, the system may optionally apply a weighting to each similarity to adjust the amount by which it influences the overall similarity metric. This may, for example, reduce the effect of model-generating instructions when the instructions are both numerous and complex, corresponding to instructions used to generate curved features for example. This in turn may ensure the similarity metric reflects a geometric similarity between the reference component model and specified component model, instead of a difference in instruction complexity.

The similarity metric may be used directly by the system to identify reference components similar to the specified component, for example by selecting the one or more reference components with the highest similarity metrics. Additionally or alternatively, the system may identify any reference components with similarity metrics that meet a similarity threshold, for example 0.95 or 95%. In some implementations, the system may provide a prompt based on a textual user input, the one or more component parameters, and/or one or more similarity metrics to a generative AI language model. The language model may tokenize data within the prompt and output one or more reference components similar to the specified component and responsive to the user input, for example by considering one or more component parameters in addition to one or more similarity metrics.

Once one or more reference components have been identified, an exemplary system may take one or more actions to apply or leverage the one or more identified components and/or to effect a reduction in component proliferation. In some implementations, the system may import the identified reference components into a CAD program for integration into existing assemblies. In other implementations, the system may display the identified reference components in a system GUI, for example within a CAD program plugin or in a standalone application, such that a user may test the integration of an identified reference component and/or compare it to the specified component. In other implementations, the system may remove the specified component and/or one or more identified reference component from a component database. Additionally or alternatively the system may designate the specified component and/or one or more identified reference component as similar to one another. In both instances, the system may reduce the likelihood a user will generate a new component instead of using an existing one in a new assembly or material order, which in turn may help mitigate the issue of component proliferation. This may be especially beneficial, in terms of a reduction in part cost and development time, at organizations such as those in the aerospace industry which may be subject to expensive and time consuming regulatory and certification procedures when developing and incorporating new components.

In some embodiments, a method for identifying components for use in a manufacturing process is provided, the method comprising: receiving a plurality of computer-aided design (CAD) files of components; receiving a user input specifying a component related to the manufacturing process; generating a similarity metric quantifying a similarity between a model of a reference component and a model of the specified component, wherein the similarity is based on: at least one first attribute of a reference component model stored within a CAD file, of the plurality of CAD files of components, wherein the at least one first attribute is selected from a group consisting of: a set of model-generating instructions, a model volume, and a set of model surface types; and at least one second attribute of a specified component model stored within a CAD file of the specified component, wherein the at least one second attribute is selected from a group consisting of: a set of model-generating instructions, a model volume, and a set of model surface types; and identifying, based on the similarity metric, one or more reference components for use in the manufacturing process.

In some embodiments, identifying the one or more reference components further comprises at least one of: identifying a reference component corresponding to a similarity metric that is higher than the similarity metric corresponding to one or more other reference components; or identifying a reference component corresponding to a similarity metric that meets a similarity threshold. In some embodiments, generating the similarity metric comprises generating at least one of: an instruction similarity based on a squared distance between a numerical representation of the set of model-generating instructions for the reference component model and a numerical representation of the set of model-generating instructions for the specified component model; a volume similarity based on a difference between the model volume of the reference component and the model volume of the specified component; or a surface similarity based on a difference between a numerical representation of the set of model surface types of the reference component and a numerical representation of the set of model surface types of the specified component. In some embodiments, generating each of the numerical representations of the sets of model-generating instructions comprises: computing, for each instruction type in a set of model-generating instructions, a reference count based on a number of references made by the instruction type to one or more other instruction types in the set; and storing each reference count in a tensor wherein a row index of the tensor and a column index of the tensor each comprise two or more instruction types in the set. In some embodiments, generating the instruction similarity comprises: computing a squared distance between a tensor corresponding to the reference component and a tensor corresponding to the specified component; and normalizing the squared distance by dividing the squared distance by an instruction normalization factor based on a magnitude of the tensor corresponding to the reference component or a magnitude of the tensor corresponding to the specified component. In some embodiments, generating the volume similarity comprises: normalizing the difference between the model volume of the reference component and the model volume of the specified component by dividing the difference by a volume normalization factor; wherein the volume normalization factor is based on the model volume of the reference component or the model volume of the specified component. In some embodiments, generating each of the numerical representations of the sets of model surface types comprises computing, for each surface type in a set of model surface types, a surface count based on a number of surfaces of the surface type in a model. In some embodiments, generating the surface similarity comprises, for each surface type: computing a surface difference between a surface count of the reference component model and a surface count of the specified component model; and normalizing the surface difference by dividing the surface difference by a surface normalization factor based on the surface count of the reference component model or the surface count of the specified component model. In some embodiments, generating the surface similarity further comprises averaging two or more normalized surface differences, wherein each normalized surface difference corresponds to a surface type. In some embodiments, computing the similarity metric further comprises computing a sum of the instruction similarity, the volume similarity, and the surface similarity. In some embodiments, computing the sum of the instruction similarity comprises: computing the sum of an instruction weighting multiplied by the instruction similarity, a volume weighting multiplied by the volume similarity, and a surface weighting multiplied by the surface similarity; wherein at least one of the instruction weighting, the volume weighting, or the surface weighting is based on a degree of complexity of at least one of the reference component model or the specified component model. In some embodiments, the degree of complexity is based on a number of model-generating instructions corresponding to generating a spline feature. In some embodiments, receiving the user input comprises receiving a textual input specifying a component related to the manufacturing process. In some embodiments, receiving the textual input comprises receiving a user query specifying the component related to the manufacturing process; and identifying the one or more reference components further comprises: retrieving, from a database, one or more parameters of a reference component corresponding to the user query; generating and providing a prompt to a generative AI language model, wherein the prompt is generated based on the user query, the one or more parameters, and the similarity metric; and receiving, from the generative AI language model and in response to the input prompt, an output comprising an identification of the one or more reference components for use in the manufacturing process. In some embodiments, the one or more parameters of the reference component comprise at least one of: an identification number, a name, a description, a category, a characteristic dimension, a supplier, a storage location, a material, or a certification. In some embodiments, the output further comprises one or more reasons for identifying the one or more reference components. In some embodiments, receiving the user input comprises receiving, from a CAD program plugin module, an indication of a CAD model. In some embodiments, the method further comprises importing into a CAD program, using a CAD program plugin module, a CAD model of at least one of the identified one or more reference components. In some embodiments, the method further comprises displaying a graphical user interface, wherein the graphical user interface comprises at least one of: a messaging module configured to allow a user to send and receive messages; or a visualization module configured to allow a user to view a CAD model. In some embodiments, the method further comprises: importing, using the graphical user interface, a CAD model of at least one of the identified one or more reference components; wherein the visualization module is configured to allow a user to view the CAD model of at least one of the identified one or more reference components. In some embodiments, the method further comprises: importing, using the graphical user interface, a CAD model of the specified component; wherein the visualization module is configured to allow a user to view the CAD model of the specified component while simultaneously viewing the at least one of the identified one or more reference components. In some embodiments, the method further comprises at least one of: removing, from one or more databases comprising one or more components, at least one component selected from a group comprising: the specified component and the identified one or more reference components; or designating, within the one or more databases, an indication of similarity for at least one component selected from a group comprising: the specified component and the identified one or more reference components. In some embodiments, designating the indication of similarity comprises recording, within the one or more databases, the similarity metric for at least one component selected from a group comprising: the specified component and the identified one or more reference components. In some embodiments, at least one CAD file, selected from a group consisting of the plurality of CAD files of components and the CAD file of the specified component, comprises a standard for the exchange of product-model data (STEP) file.

In some embodiments, a system for identifying components for use in a manufacturing process is provided, the system comprising one or more processors and memory storing instructions that, when executed by the one or more processors, cause the system to: receive a plurality of computer-aided design (CAD) files of components; receive a user input specifying a component related to the manufacturing process; generate a similarity metric quantifying a similarity between a model of a reference component and a model of the specified component, wherein the similarity is based on: at least one first attribute of a reference component model stored within a CAD file, of the plurality of CAD files of components, wherein the at least one first attribute is selected from a group consisting of: a set of model-generating instructions, a model volume, and a set of model surface types; and at least one second attribute of a specified component model stored within a CAD file of the specified component, wherein the at least one second attribute is selected from a group consisting of: a set of model-generating instructions, a model volume, and a set of model surface types; and identify, based on the similarity metric, one or more reference components for use in the manufacturing process.

In some embodiments, a non-transitory computer readable storage medium storing instructions for identifying components for use in a manufacturing process is provided, wherein the instructions, when executed by one or more processors of an electronic device, cause the device to: receive a plurality of computer-aided design (CAD) files of components; receive a user input specifying a component related to the manufacturing process; generate a similarity metric quantifying a similarity between a model of a reference component and a model of the specified component, wherein the similarity is based on: at least one first attribute of a reference component model stored within a CAD file, of the plurality of CAD files of components, wherein the at least one first attribute is selected from a group consisting of: a set of model-generating instructions, a model volume, and a set of model surface types; and at least one second attribute of a specified component model stored within a CAD file of the specified component, wherein the at least one second attribute is selected from a group consisting of: a set of model-generating instructions, a model volume, and a set of model surface types; and identify, based on the similarity metric, one or more reference components for use in the manufacturing process.

In some embodiments, a method for identifying components for use in a manufacturing process is provided, the method comprising: receiving a plurality of computer-aided design (CAD) files of components; receiving a textual user query related to the manufacturing process; retrieving, from a CAD file of the plurality of CAD files of components, at least one attribute corresponding to the user query and selected from a group consisting of: a set of model-generating instructions, a model volume, and a set of model surface types; generating and providing a prompt to a generative AI language model, wherein the prompt is generated based on the user query and the at least one attribute; and receiving, from the generative AI language model and in response to the input prompt, an output comprising an identification of the one or more components for use in the manufacturing process.

In some embodiments, generating and providing the prompt to the generative AI language model further comprises: retrieving, from a database, one or more parameters of a component corresponding to the user query; wherein the prompt is generated based additionally on the one or more parameters; and wherein the one or more parameters comprise at least one of: an identification number, a name, a description, a category, a characteristic dimension, a supplier, a storage location, a material, or a certification. In some embodiments, the output further comprises one or more reasons for identifying the one or more components. In some embodiments, the method further comprises importing into a CAD program, using a CAD program plugin module, a CAD model of at least one of the identified one or more components. In some embodiments, the method further comprises displaying a graphical user interface, wherein the graphical user interface comprises at least one of: a messaging module configured to allow a user to send and receive messages; or a visualization module configured to allow a user to view a CAD model. In some embodiments, the method further comprises: importing, using the graphical user interface, a CAD model of at least one of the identified one or more components; wherein the visualization module is configured to allow a user to view the CAD model of at least one of the identified one or more components. In some embodiments, the method further comprises at least one of: removing, from one or more databases comprising one or more components, at least one of the identified one or more components; or designating, within the one or more databases, an indication of similarity for at least one of the identified one or more components. In some embodiments, designating the indication of similarity comprises recording, within the one or more databases, the similarity metric for at least one of the identified one or more components. In some embodiments, at least one of the plurality of CAD files of components comprises a standard for the exchange of product-model data (STEP) file.

In some embodiments, a system for identifying components for use in a manufacturing process is provided, the system comprising one or more processors and memory storing instructions that, when executed by the one or more processors, cause the system to: receive a plurality of computer-aided design (CAD) files of components; receive a textual user query related to the manufacturing process; retrieve, from a CAD file of the plurality of CAD files of components, at least one attribute corresponding to the user query and selected from a group consisting of: a set of model-generating instructions, a model volume, and a set of model surface types; generate and provide a prompt to a generative AI language model, wherein the prompt is generated based on the user query and the at least one attribute; and receive, from the generative AI language model and in response to the input prompt, an output comprising an identification of the one or more components for use in the manufacturing process.

In some embodiments, a non-transitory computer readable storage medium storing instructions for identifying components for use in a manufacturing process is provided, wherein the instructions, when executed by one or more processors of an electronic device, cause the device to: receive a plurality of computer-aided design (CAD) files of components; receive a textual user query related to the manufacturing process; retrieve, from a CAD file of the plurality of CAD files of components, at least one attribute corresponding to the user query and selected from a group consisting of: a set of model-generating instructions, a model volume, and a set of model surface types; generate and provide a prompt to a generative AI language model, wherein the prompt is generated based on the user query and the at least one attribute; and receive, from the generative AI language model and in response to the input prompt, an output comprising an identification of the one or more components for use in the manufacturing process.

In some embodiments, a method for identifying two or more similar components is provided, the method comprising: receiving a plurality of computer-aided design (CAD) files of components; generating a similarity metric quantifying a similarity between a model of a first component and a model of a second component, wherein the similarity is based on: at least one first attribute of a first component model stored within a CAD file, of the plurality of CAD files of components, wherein the at least one first attribute is selected from a group consisting of: a set of model-generating instructions, a model volume, and a set of model surface types; and at least one second attribute of a second component model stored within a CAD file of the second component, wherein the at least one second attribute is selected from a group consisting of: a set of model-generating instructions, a model volume, and a set of model surface types; and determining that the similarity metric meets a similarity threshold.

In some embodiments, generating the similarity metric comprises generating at least one of: an instruction similarity based on a squared distance between a numerical representation of the set of model-generating instructions for the first component model and a numerical representation of the set of model-generating instructions for the second component model; a volume similarity based on a difference between the model volume of the first component and the model volume of the second component; or a surface similarity based on a difference between a numerical representation of the set of model surface types of the first component and a numerical representation of the set of model surface types of the second component. In some embodiments, generating each of the numerical representations of the sets of model-generating instructions comprises: computing, for each instruction type in a set of model-generating instructions, a reference count based on a number of references made by the instruction type to one or more other instruction types in the set; and storing each reference count in a tensor wherein a row index of the tensor and a column index of the tensor each comprise two or more instruction types in the set. In some embodiments, generating the instruction similarity comprises: computing a squared distance between a tensor corresponding to the first component and a tensor corresponding to the second component; and normalizing the squared distance by dividing the squared distance by an instruction normalization factor based on a magnitude of the tensor corresponding to the first component or a magnitude of the tensor corresponding to the second component. In some embodiments, generating the volume similarity comprises: normalizing the difference between the model volume of the first component and the model volume of the second component by dividing the difference by a volume normalization factor; wherein the volume normalization factor is based on the model volume of the first component or the model volume of the second component. In some embodiments, generating each of the numerical representations of the sets of model surface types comprises computing, for each surface type in a set of model surface types, a surface count based on a number of surfaces of the surface type in a model. In some embodiments, generating the surface similarity comprises, for each surface type: computing a surface difference between a surface count of the first component model and a surface count of the second component model; and normalizing the surface difference by dividing the surface difference by a surface normalization factor based on the surface count of the first component model or the surface count of the second component model. In some embodiments, generating the surface similarity further comprises averaging two or more normalized surface differences, wherein each normalized surface difference corresponds to a surface type. In some embodiments, computing the similarity metric further comprises computing a sum of the instruction similarity, the volume similarity, and the surface similarity. In some embodiments, computing the sum of the instruction similarity comprises: computing the sum of an instruction weighting multiplied by the instruction similarity, a volume weighting multiplied by the volume similarity, and a surface weighting multiplied by the surface similarity; wherein at least one of the instruction weighting, the volume weighting, or the surface weighting is based on a degree of complexity of at least one of the first component model or the second component model. In some embodiments, the degree of complexity is based on a number of model-generating instructions corresponding to generating a spline feature. In some embodiments, the method further comprises at least one of: removing, from one or more databases comprising one or more components, at least one of the first component or the second component; or designating, within the one or more databases, an indication of similarity for at least one of the first component or the second component. In some embodiments, designating the indication of similarity comprises recording, within the one or more databases, the similarity metric for at least one of the first component or the second component. In some embodiments, at least one of the plurality of CAD files of components comprises a standard for the exchange of product-model data (STEP) file.

In some embodiments, a system for identifying two or more similar components is provided, the system comprising one or more processors and memory storing instructions that, when executed by the one or more processors, cause the system to: receive a plurality of computer-aided design (CAD) files of components; generate a similarity metric quantifying a similarity between a model of a first component and a model of a second component, wherein the similarity is based on: at least one first attribute of a first component model stored within a CAD file, of the plurality of CAD files of components, wherein the at least one first attribute is selected from a group consisting of: a set of model-generating instructions, a model volume, and a set of model surface types; and at least one second attribute of a second component model stored within a CAD file of the second component, wherein the at least one second attribute is selected from a group consisting of: a set of model-generating instructions, a model volume, and a set of model surface types; and determine that the similarity metric meets a similarity threshold.

In some embodiments, a non-transitory computer readable storage medium storing instructions for identifying two or more similar components is provided, wherein the instructions, when executed by one or more processors of an electronic device, cause the device to: receive a plurality of computer-aided design (CAD) files of components; generate a similarity metric quantifying a similarity between a model of a first component and a model of a second component, wherein the similarity is based on: at least one first attribute of a first component model stored within a CAD file, of the plurality of CAD files of components, wherein the at least one first attribute is selected from a group consisting of: a set of model-generating instructions, a model volume, and a set of model surface types; and at least one second attribute of a second component model stored within a CAD file of the second component, wherein the at least one second attribute is selected from a group consisting of: a set of model-generating instructions, a model volume, and a set of model surface types; and determine that the similarity metric meets a similarity threshold.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

The patent or application file contains at least one drawing executed in color. Copies of this patent or patent application publication with color drawings(s) will be provided by the Office upon request and payment of the necessary fee.

A better understanding of the features and advantages of the present disclosure will be obtained by reference to the following detailed description that sets forth illustrative embodiments, in which the principles of the disclosure are utilized, and the accompanying figures of which:

FIG. 1 depicts an exemplary system for identifying components, according to some embodiments.

FIG. 2A depicts an exemplary process for identifying reference components, according to some embodiments.

FIG. 2B depicts an exemplary process for generating normalized instruction similarities, according to some embodiments.

FIG. 2C depicts an exemplary process for generating normalized volume similarities, according to some embodiments.

FIG. 2D depicts an exemplary process for generating normalized surface similarities, according to some embodiments.

FIG. 3A depicts an exemplary STEP file used for generating instruction similarities, according to some embodiments.

FIG. 3B depicts an exemplary relationship tree for generating surface similarities, according to some embodiments.

FIG. 3C depicts an exemplary tensor for generating surface similarities, according to some embodiments.

FIG. 3D depicts an exemplary forest matrix for generating surface similarities, according to some embodiments.

FIG. 3E depicts exemplary plane surfaces, according to some embodiments.

FIG. 3F depicts exemplary B-spline surfaces, according to some embodiments.

FIG. 3G depicts an exemplary surface difference matrix, according to some embodiments.

FIG. 4A depicts an exemplary component for similarity metric comparison, according to some embodiments.

FIG. 4B depicts an exemplary component for similarity metric comparison, according to some embodiments.

FIG. 4C depicts an exemplary component for similarity metric comparison, according to some embodiments.

FIG. 4D depicts an exemplary component for similarity metric comparison, according to some embodiments.

FIG. 5A depicts an exemplary graphical user interface, according to some embodiments.

FIG. 5B depicts an exemplary graphical user interface, according to some embodiments.

FIG. 6 depicts an exemplary process for identifying components, according to some embodiments.

FIG. 7A depicts exemplary outputs including identified components, according to some embodiments.

FIG. 7B depicts exemplary outputs including identified components, according to some embodiments.

FIG. 8A depicts exemplary outputs including component details, according to some embodiments.

FIG. 8B depicts exemplary outputs including component details, according to some embodiments.

FIG. 9 depicts an exemplary process for removing or designating the similarity of components, according to some embodiments.

FIG. 10 depicts an exemplary similarity metric heatmap, according to some embodiments.

FIG. 11A depicts an exemplary component point cloud, according to some embodiments.

FIG. 11B depicts an exemplary component point cloud, according to some embodiments.

FIG. 11C depicts an exemplary component point cloud, according to some embodiments.

FIG. 11D depicts an exemplary component point cloud, according to some embodiments.

FIG. 12 depicts an exemplary computing system, according to some embodiments.

### DETAILED DESCRIPTION

Disclosed herein are systems and methods for identifying one or more components for use in a manufacturing process that are similar to a specified component, thereby enabling a user to more easily select for use an existing component instead of creating a new one. An exemplary system may interface to one or more databases including, for example, a CAD file database and/or a component parameter database to gain information about an organization's library of components, for example manufacturing components that have been approved for use and/or that meet certain regulatory standards. The system may receive an input from a user specifying a component and use that input to obtain a CAD file of the component, for example from a CAD program plugin and/or from the CAD file database. The system may extract one or more attributes of the CAD model from the CAD file, for example relating to model-generating instructions, model volume, and/or model surface types that may be contained within the text-based CAD file of the specified component. The system may further extract one or more parameters related to the specified component and/or reference components from the component parameter database, and select one or more reference components based on the extract parameters and/or attributes. With one or more reference component selected, the system may extract one or more CAD files of the selected one or more reference components and extract attributes of the CAD models stored within the extracted CAD files. As with the attributes of the specified component model, these attributes of the one or more reference component models may correspond to model-generating instructions, model volume, and/or model surface types contained within the CAD files of the reference components.

The system may then use the attributes of the reference and specified component models to generate a similarity metric quantifying the geometric similarity between a reference component CAD model and the specified component CAD model. This similarity metric may be based on normalized similarity values that may represent the similarity between the model-generating instructions of each text-based CAD file, the model volumes, and/or the number of surface types making up each model. These similarity values may be summed to form the overall similarity metric and the sum may be weighted to adjust the degree to which each of the constituent similarity values effect the similarity metric. For example, for comparisons in which one or both CAD models of each component include many complex model-generating instructions, the weight placed on the instruction similarity value may be lowered to ensure the similarity metric reflects a difference in geometry instead of a difference significantly influenced by instruction complexity.

This similarity metric may be used directly to identify one or more reference components, for example based a determination that the reference components correspond to the highest similarity metrics and/or that the corresponding similarity metrics meet a similarity threshold. Alternatively or additionally, the similarity metric may be combined with a textual user input or query and/or with component parameter data to form a prompt provided to a commercially available generative AI language model which may tokenize data in the prompt and produce an output identifying one or more reference components, taking into account component parameter information in addition to similarity metric information. For example, the language model may take into account project or design constraints that the user may provide in the user input. For example the user may specify that the reference components may need to be of a certain material or meet a certain specification in addition to being similar to ta specified component. The language model may thus filter reference components with high similarity metrics based on whether they include materials and/or certifications similar to those specified in the user prompt.

In either case, once one or more reference components have been identified, the system may take one or more actions to assist an organization in reducing and/or preventing the growth of component proliferation. In some implementations, the system may import the one or more reference components into a CAD program, for example, into a preexisting assembly for a user or engineer to evaluate the impact of switching from the specified component to the one or more reference components. In other implementations, the system may display a CAD model of the one or more reference components in a system GUI within a CAD program plugin and/or within a standalone application. This may allow a user to test different configurations for the one or more reference components without impacting a CAD assembly used to control production components, and/or to compare the reference component to the specified component. In other implementations the system may remove from one or more component databases the specified component and/or the one or more identified reference components, and/or may designate the similarity relationships between the components, thereby making it less likely a user may create a new component instead of referencing and selecting a preexisting, preapproved component.

The language model may exist within a CAD program plugin or in a standalone application adjacent to a CAD model visualization portion. The model may take the form of a chatbot allowing a user to interact with and receive insights from the component identification system. In some implementations, the user may not specify a component and may instead provide a more open-ended query to which the system may combine with extracted attributes and/or parameters to form a prompt for the language model which may then output components present in the organization's library responsive to the user's query. In other implementations, the system may preprocess the CAD file database to generate similarity metrics representing the similarity of one or more, and optionally all, components within the database relative to one or more, and optionally all, other components within the database. This preprocessing of the database may enable a component identification system and/or generative AI language model to combine comprehensive similarity metric data with other component parameters to create visualizations and other resources that let engineers and other component management users identify redundancies and take actions to reduce component proliferation.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

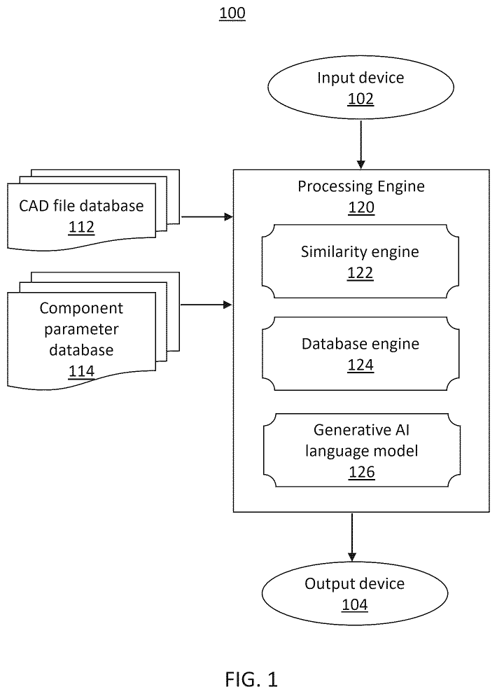

FIG. 1 depicts an exemplary system 100 for identifying manufacturing components. Component identification system 100 may include an input device 102 that enables users to interact with and provide data or commands to the system. For example, input device 102 may include a keyboard, mouse, touchscreen, camera, and/or microphone. Input device 102 may be used to specify a component related to a manufacturing process that a user wishes to compare to one or more reference components, and/or to interact with a chatbot to better understand available components. System 100 may further include an output device 104 that translates processed data into a human-readable or usable format. For example, output device 104 may include a display device such as a monitor or a projector, a speaker, and/or a haptic feedback device.

Component identification system 100 may further comprise a processing engine 120 such as a computer that may include one or more processing units such as a central processing unit and/or graphics processing unit along with memory management units. Processing engine 120 may interface to and/or receive data from a CAD file database 112 that may contain one or more CAD files that store models of components used by a manufacturing organization and/or available for procurement from one or more suppliers. Processing engine 120 may also interface to and/or receive data from a component parameter database that may contain one or more parameters for components, optionally including the components stored in CAD file database 112. These parameters may include identification numbers of components, names of components, component descriptions, component categories, component characteristic dimensions, component suppliers, component storage locations, component materials, and/or component certifications.

Processing engine 120 may include a similarity engine configured to compute a similarity metric based on a comparison of one or more attributes of two components, for example a specified component and a reference component as described in greater detail below. These attributes may be stored within CAD files of CAD file database 112 and extracted by processing engine 120. Processing engine 120 may further include a database engine 124 configured to extract and process one or more parameters located in component parameter database 114 and a generative AI language model 126. Generative AI language model 126 may include one or more commercially available large language models that allow for tokenizing of input information based on a prompt. Model 126 may form inputs based on user inputs, parameters, component attributes, and/or similarity metrics, and may output relevant reference components along with the reasons for selecting each. This AI-based chatbot feature is described in greater detail below. Reference components and/or related insights may be communicated to the user by output device 104. Reference components found to be similar to a specified component, and/or the specified component itself may be imported into a CAD program, visualized within a GUI, and/or marked as similar and/or removed from databases to enable a reduction in component proliferation for example by reducing the creation of new components.

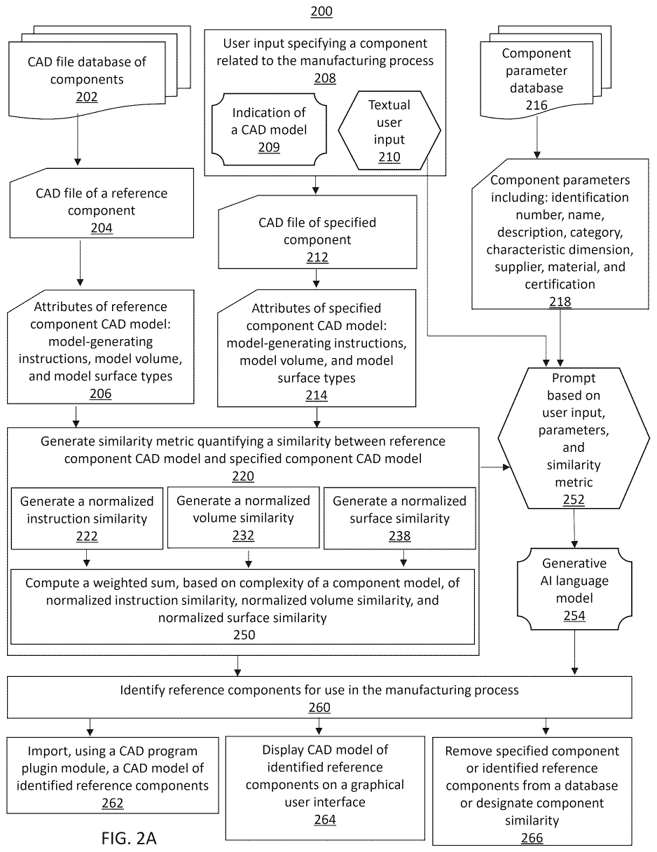

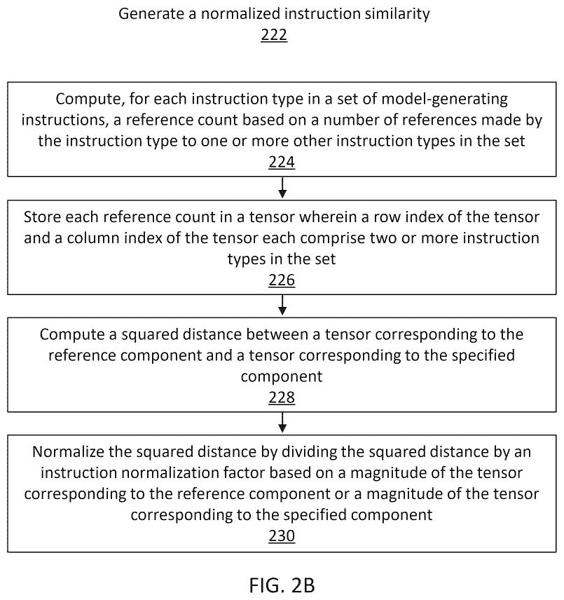

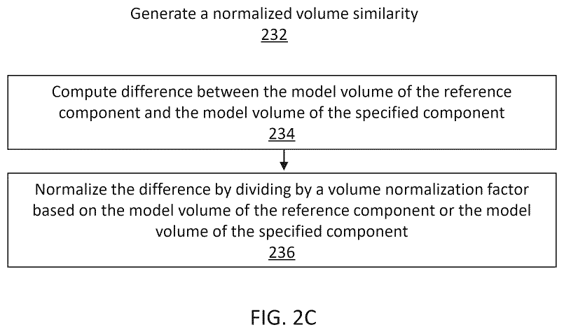

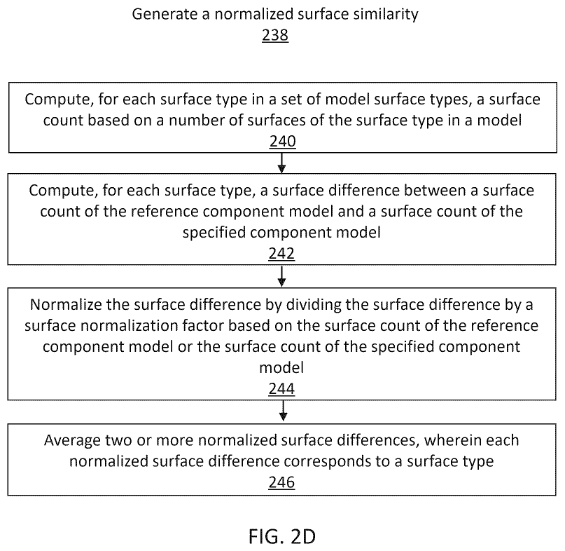

FIG. 2 depicts exemplary process 200 for identifying reference components. As mentioned above, an exemplary system for identifying components may interface to and/or receive data from a CAD file database 202 that may include the CAD files of one or more components as well as metadata indicating, for example, the category of the component (e.g. “screw”). For example, CAD file database 202 may include a part library of a manufacturing or engineering organization and may contain a multitude of components that engineers and/or procurement coordinators may reference when designing new assemblies and/or procuring sets of components, for example to satisfy a bill of materials. The component identification system may also interface to and/or receive data from a component parameter database 216 that may store one or more parameters corresponding to a plurality of components including, for example, the one or more components stored in CAD file database 202. Component parameters database 216 may be a cloud-based database such as an Azure PostgreSQL database. Sets of the one or more parameters may each refer to a reference component and may include, as mentioned above, identification numbers of components, names of components, component descriptions, component categories, component characteristic dimensions, component suppliers, component storage locations, component materials, and/or component certifications. Component parameter database 202 may take the form of a spreadsheet and/or a relational data structure enabling the parameters to be associated with one or more components. This association may allow users and/or automated systems to readily access and understand these relationships.

Component parameter database 202 may include along with the parameters associated with a particular components, a linking of parameters to those that are similar. For example, a particular certification parameter and/or a particular material parameter may have connections to one or more additional certifications and/or one or more additional materials that the system and/or that a user has deemed sufficiently related to the particular certification parameter and/or a particular material parameter to warrant a connection. Such connections may be based on user specification of relatedness and/or on a machine learning-based approach in which an algorithm may be trained on dataset including a plurality of components, associated parameters, and data indicating relationships between components and/or assignment within pre-existing assemblies, enabling the algorithm to understand which parameters may be associated with which other parameters. For example, an algorithm may learn that parts with particular certifications and/or particular materials are often placed together or treated as interchangeable in certain assemblies. Such connections may enable component identification system to conduct “fuzzy” searches of component parameter database 216, which may be useful in returning a set of components for use in a manufacturing process even in instances in which an exact match to a user query and/or a duplicate component to the one specified cannot be located.

CAD file database 202 and/or component parameter database 216 may be a part of a product lifecycle management system such as PTC Windchill that enables the management of CAD files and/or other engineering data and that may directly interface to a CAD program such as PTC Creo. Additionally or alternatively, databases 202 and 216 may be stored on one or more cloud-based servers, for example servers based on Microsoft Azure or Amazon Web Services, such that users may obtain access to one or both databases remotely. Additionally or alternatively, an exemplary system itself may be stored on such a cloud-based server, with a user connecting remotely to the system, for example using a webpage and/or a remote PC application.

In addition to data from and/or access to multiple databases, an exemplary system for identifying reference components may receive a user input 208 that may specify a component that may relate a manufacturing process and that the user is interested in learning more about. For example, the user may wish to know whether similar reference components exist and/or what about those reference components makes them similar to a specified component. For example, an engineer may be designing a new assembly and wish to know whether a component similar to one they have just designed and/or have identified exists within a reference library of parts the organization has used in the past and/or certified for use in specified applications.

User input 208 may be supplied by a CAD program user, for example an engineer that has just created a component and/or imported a reference component into an assembly within a CAD program such as SolidWorks, PTC Creo, etc. The component identification system may include a CAD program plugin allowing the system to interface to and/or receive data from one or more CAD programs. For example, the plugin may be developed in a computing language the CAD program supports such as C++ and/or Python, and may leverage the program's Application Programming Interface to interact with the CAD program. To supply user input 208 using the plugin, an engineer and/or other CAD program user may first ensure the plugin has been enabled and may provide an indication 209 of a CAD model of one or more components to specify the model to the component identification system. In some implementations, the CAD program user may type the name and/or component identification number into a text-entry box within the CAD program and enabled by the plugin, forming textual user input 210. In other implementations, the CAD program user may select one or more components within the CAD program and indicate, by one or more methods, that these components are to form inputs for the plugin, thereby forming indication 209. For example, the user may select a component and select a button within the CAD program and enabled by the plugin and/or activate a key on their keyboard that the plugin may interpret as providing indication 209 indicating a component for input to the component identification system. Alternatively or additionally, the plugin may reference components open on a user's screen, for example the components forming an assembly, and may provide the identification numbers and/or CAD files of open components such that the system may analyze each in series as a specified component. The resulting set of reference components for each specified component may be displayed within the CAD plugin, should the user wish to know which alternate components may be sufficiently similar to those currently in a design to allow for substitution. In some implementations, specifying the component for input using such a CAD program plugin may enable the plugin to import, directly from the CAD program, a CAD file 212 of the specified component. In other implementations, specification of the component via the CAD program interface or text-entry box may enable the plugin to provide this information to the component identification system which may then use, for example, CAD file database 202 to locate and import a CAD file 212 of the specified component.

Additionally or alternatively, user input 208 may be supplied by entering information related to a component, for example the component's identification number or name into a text-entry input box, forming textual user input 210. This text-entry input box may be a part of a CAD program plugin as mentioned above, may be a part of a separate component identification GUI, and/or may form a part of an AI-enabled chatbot, for example the text-entry portion of the chatbot, as discussed in greater detail below. Entry of information corresponding to the specified component may allow the system to reference a separate resource, for example CAD file database 202, to gain access to the CAD file 212 of the specified component. Thus, the component identification system may obtain a CAD file 212 of the specified component, directly from a CAD program plugin and/or from a database such as CAD file database 202.

In the case that the specified component is also an existing reference component, an exemplary component identification system may locate utilize CAD file database 202 and/or component parameter 216 to locate a CAD file and/or parameters corresponding to the specified component to identify one or more reference components sufficiently similar to the specified component.

The system may next locate one or more reference components for comparison to the one or more specified components, for example to determine one or more reference components with sufficient similarity to the specified component. The system may use one or more approaches to locate a reference components for comparison. For example, data stored within one or more of CAD file database 202 and/or component parameter database 216 may indicate which set of reference components share a high-level similarity with the one or more specified components. For example, a user may specify a particular type of fastener of a particular length, for example a 25 mm long cap screw, and the metadata of CAD file database 202 and/or the parameters of component parameter database 216 may enable the system to locate an initial set of reference components for comparison to the specified component. For example, the metadata of CAD file database 202 and/or parameters of component parameter database, may indicate a set of 80 reference components that are similar in type and length to the specified 25 mm long cap screw. In some implementations, the system may allow a user to specify both a specified component and one or more reference components, for example to check which of the one or more reference components has the highest similarity score. In some implementations, the system may compare the component to a larger subset of reference components, for example all screws within the CAD file database. In other implementations, the system may compare the components to all reference components within CAD file database 202 to determine which one or more reference components is the most similar to the specified component.

With the one or more reference components to be compared to the specified component identified, method 200 may next entail extracting a CAD file 204 of one of the one or more reference components from CAD file database 202, and one or more parameters 218 associated with the specified and/or reference component. These one or more reference parameters may include an identification number, e.g. “E62165780,” a name, e.g. “M10 cap screw,” a description, e.g. “cap screw for wiring assembly,” a characteristic dimension, e.g. “25 mm,” a material, e.g. “18-8 stainless steel,” and a certification, e.g. “AS9100.”

Each of CAD file of a reference component 204 and/or CAD file of a specified component 212 extracted or otherwise obtained by the system may contain one or more attributes that correspond to a CAD model of the corresponding component. These one or more attributes may be encoded in the syntax of each CAD file and may contain information sufficient to define the geometric shape and/or coordinate system of the CAD model. For example, each CAD file may be a text-based file of one or more of the following formats: standard for the exchange of product model data (STEP), SolidWorks part file (SLDPRT), PTC Creo part file (PRT), initial graphics exchange specification (IGES), and/or standard ACIS text (SAT). These one or more attributes may include instructions for generating a CAD model of the component, for example the operations that a CAD program would take to create and display a component model. These one or more attributes may additionally or alternatively include a volume of the CAD model of the component, for example obtained by summing various constituent volumes that make up a component model. These one or more attributes may additionally or alternatively include an indication of one or more model surface types, for example the number of surfaces of each surface type that make up a component model.

Thus, following identification of CAD file of a reference component 204 and/or CAD file of a specified component 212, the component identification system may extract one or more attributes 206 of the reference component CAD model and/or one or more attributes 214 of the specified component CAD model. These attributes may include, as mentioned above, model-generating instructions, model volume, and/or model surface types corresponding of each CAD model.

Process 200 may next entail, at step 220, using attributes of the reference component CAD model 206 and/or attributes of the specified component model 214 to generate a similarity metric quantifying a similarity between the reference component CAD model and the specified component CAD model. Generation of this similarity metric may involve the comparison of the attributes of the reference and specified models. In some implementations, this comparison may involve comparing the model-generating instructions of the reference and specified models, the model volumes of the reference and specified models, and/or the surface similarity of the reference and specified models so as to generate an instruction similarity, a volume similarity, and/or a surface similarity, respectively. Each of these variables may be normalized enabling comparisons of the two models based on the net effect of the three aforementioned similarities. In such implementations, process 200 may entail generation of a normalized instruction similarity via exemplary process 222, a normalized volume similarity via exemplary process 232, and/or a normalized surface similarity via exemplary process 238.

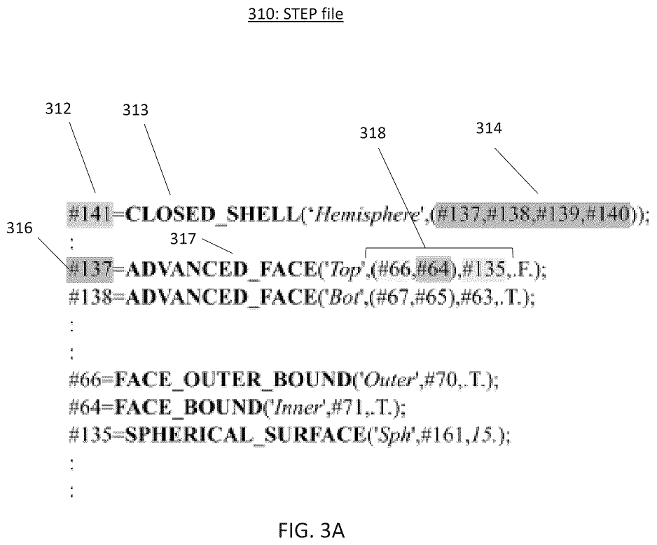

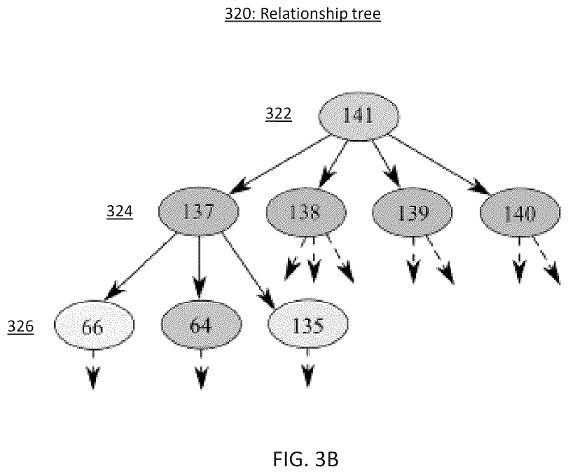

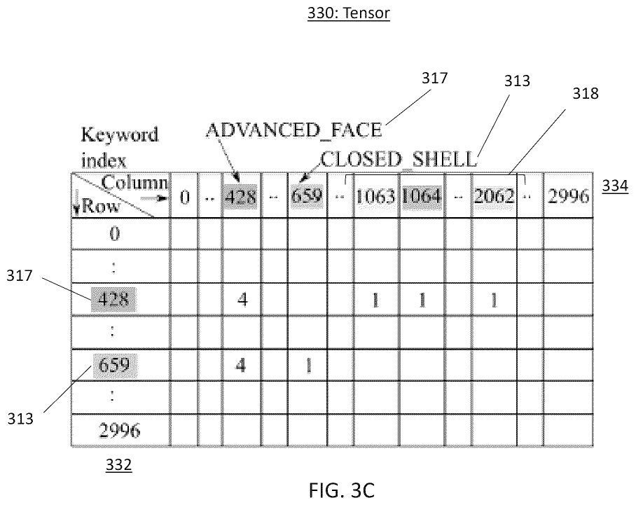

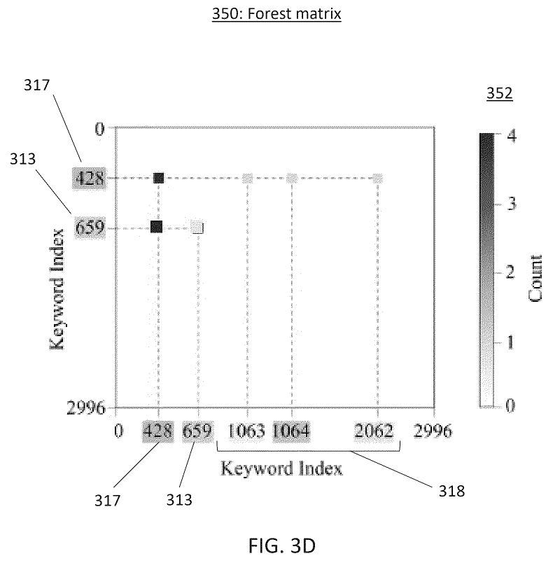

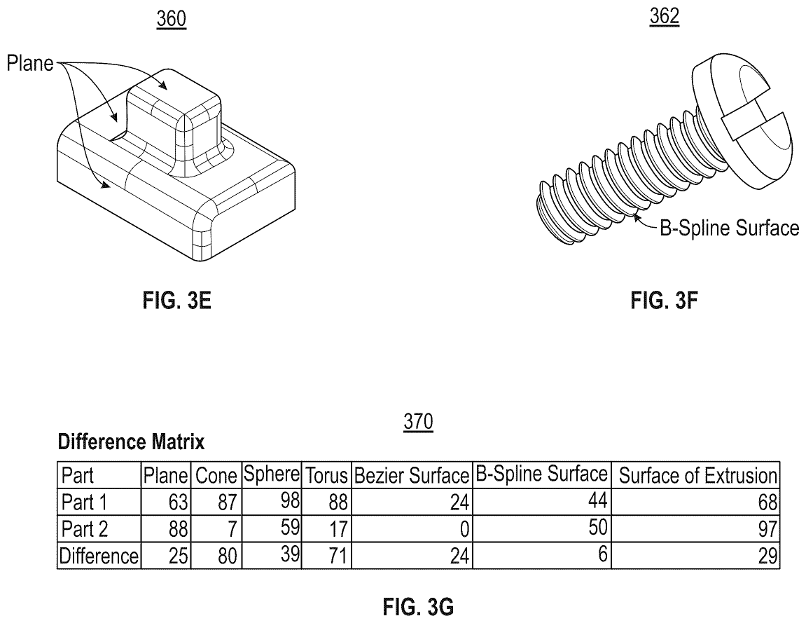

FIG. 2B depicts exemplary process 222 for generating a normalized instruction similarity. As mentioned above, each CAD file may include multiple text-based instructions that a CAD program may use to generate a CAD model of a corresponding component. For example, as shown in view 310 of FIG. 3A, a CAD file such as a STEP file may include text-based instructions that reference other instructions to complete one step of generating a CAD file. As shown in view 310, each instruction may correspond to a reference number, a keyword, and one or more references to one or more other instructions, identified by their corresponding reference numbers. For example, the first instruction includes reference number 312 (“#141”), keyword 313 (“CLOSED_SHELL”), and references to other instructions 314 (“#137, #138, #139, #140”) in a parenthetical argument portion of the instruction. For example, this first instruction may instruct a CAD model to create a model of an object that is hollow yet with surfaces that are completely closed and/or “watertight.” This first instruction instructs the CAD program to reference other several other references, for example the second listed instruction with reference number 316 (“#137”) that includes keyword 314 (“ADVANCED_FACE”) instructing the CAD program to create one of the faces making up the shell component, in turn including references to several other components 318 (“#66, #64, #135”). As shown in view 320 of FIG. 3B, these relationships can be depicted in a relationship tree based on reference number. The tree depicted in view 320 includes the relationships found in the first instruction of view 310. At level 322, the reference number of the first instruction 312 (#141) is shown. At level 324, the reference numbers that first instruction 312 reference (314 or “#137, #138, #139, #140”) are shown. At level 326, detail of the relationships of the second instruction of view 310, instruction with reference number 316 (“#137”), are depicted, including the references 318 the second instruction references (“#66, #64, #135”). In this way, relationships between keyword types forming the root (level 322), branch (level 324), and leaf (level 326) of the relationship tree may be readily visualized.

Such a relationship tree may be used at step 224 of process 222 of FIG. 2B to generate a reference count representing the number of times one instruction type, for example one keyword type, references each other instruction type. For example, in FIG. 3A, the STEP file view 310 displays two keyword types, 313 and 317, “CLOSED_SHELL” and “ADVANCED_FACE” respectively. For example, from the relationship tree view 320, it is apparent that keyword #141 of row 322 references four keywords (#137, #138, #139, and #140). As seen in STEP file view 310, keyword #141 corresponds to first keyword type (“CLOSED_SHELL”) while keywords #137, #138, #139, and #140 each correspond to a second keyword type (“ADVANCED_FACE”). Thus, “CLOSED_SHELL” references “ADVANCED_FACE” four times. Further, at row 324, one instance of “ADVANCED_FACE,” keyword #137, makes one reference to keywords #66, #64, and #135 at row 326, each corresponding to a different keyword type.

At step 226 of process 222 of FIG. 2B, each reference count representing the number of times one keyword type references another keyword type, may be stored in a tensor data structure with row indexes and column indexes that include one or more instruction types. View 330 of FIG. 3C depicts an exemplary tensor populated by the keyword types present in relationship tree view 320. The row index 332 and column index 334 may match one another and may be referred to collectively as a “keyword index.” This index may be formed by assigning a value for each keyword type in the index. The keyword index may increase incrementally, with the final value representing the total number of keyword types in the index. For example, keyword type 317, “ADVANCE FACE” is represented by index 428, and keyword type 313, “CLOSED_SHELL” may be represented by index 659. Keyword types 318 may be represented by indexes 1063, 1064, and 2062.

The exemplary tensor of view 330 may include reference counts at one or more positions of the tensor. Each reference count may occupy a separate tensor position which may be identified by the row index and column index. Each reference count may be assigned based on the number of times the keyword corresponding to the row index referenced the keyword corresponding to the column index. For example, keyword type 313, “CLOSED_SHELL,” corresponding to keyword index 659, referenced keywords corresponding to keyword index 428 four times, thus the position with 659 as the row index value and 428 as the column index is equal to 4. Similarly keyword type 317, “ADVANCE FACE,” represented by index 428, referenced keywords corresponding to keyword indexes 1063, 1064, and 2062 once, thus each of these respective tensor position is equal to 1. The value of the tensor diagonal, for example the positions at which the row index equals the column index may represent the root occurrences, for example equaling the number of uses of a keyword type corresponding to the keyword index shared by the row and column indexes. For example, in view 330, at the position corresponding to row and column index 428, or keyword type “ADVANCED_FACE,” has four reference numbers (#137, #138, #139, and #140) associated with it. Thus, this tensor position is equal to 4. Tensor positions with empty values may correspond to reference counts equal to 0.

View 350 of FIG. 3D represents an additional configuration by which to view keyword type relationship information. For example, view 350 depicts the intersections between keywords corresponding to keyword indexes 317, 313, and 318. Here, the reference count is communicated using gradient 352, with each datapoint colored according to the number of references made by the keyword represented by the vertical axis keyword index to keywords represented by the horizontal axis keyword index. For example, keyword type 313, “CLOSED_SHELL,” corresponding to keyword index 659, referenced keywords corresponding to keyword index 428 four times, thus the datapoint with 659 as the vertical axis value and 428 as the horizontal axis is equal to 4. Similarly, keyword type 317, “ADVANCE FACE,” represented by index 428, referenced keywords corresponding to keyword indexes 1063, 1064, and 2062 once, thus each of these respective forest matrix datapoints is equal to 1. As in the tensor of view 330, the reference count of datapoints corresponding to equal vertical and horizontal axis values is equal to the number of root occurrences, for example equaling the number of uses of a keyword type corresponding to the keyword index shared by the vertical and horizontal axis values. For example, in view 350, the datapoint with a vertical and horizontal axis value corresponding to keyword index 428, or keyword type “ADVANCED_FACE,” has four reference numbers (#137, #138, #139, and #140) associated with it. Thus, this datapoint is equal to 4.

Returning to FIG. 2B, at step 228 of process 222, tensors such as the exemplary tensor shown in view 330 of FIG. 3C that each correspond to a separate CAD file, for example separate STEP files, may be compared. To accomplish this, the system may compare the squared distance between the tensor corresponding to the reference component and the tensor corresponding to the specified component. To compute the squared distance, the system may first compute the element-wise difference by computing the difference between two elements or values at corresponding positions of two tensors. If one tensor has a different number of values than a tensor to which it is being compared, one or more of several techniques may be utilized to compare corresponding positions. In some implementations, the smaller tensor may have values equal to 0 padded or added to the tensor such that it becomes equal in size to the larger tensor. In other implementations, the larger tensor may be cropped or trimmed such that it becomes equal in size to the smaller tensor. In other implementations, the larger tensor may be resized by applying interpolation to one or more portions of the larger tensor to produce average values in place of original values. In some implementations, the system may ensure that the instruction or keyword types forming the row index and column index of each tensor match in terms of order and value, such that any instruction or keyword type not present in both tensors may not be included in the final tensor used to compute squared distance.

In this way, the system may form a matrix containing element-wise difference values at each position. Once the matrix containing element-wise difference has been computed, the system may compute the squared distance by squaring each element-wise difference value and summing all resulting value. At step 230, this squared distance may be normalized by dividing the squared distance by an instruction normalization factor that may be based on a magnitude of the tensor corresponding to the reference component or a magnitude of the tensor corresponding to the specified component. To compute a magnitude of each tensor, the system may square each value of the tensor, sum the squares of all values, and compute the square root of the resulting sum. For example, the instruction normalization factor may be based on the tensor with the higher magnitude as between the tensor corresponding to the reference component and the tensor corresponding to the specified component. Alternatively or additionally, the instruction normalization factor may be based on an average magnitude of the tensor corresponding to the reference component model and the tensor corresponding to the specified component model.

Thus, the normalized instruction similarity, as a function of distance between two tensors, may be higher when the instruction types and relationships between referenced instruction types are less similar and lower when instruction types and relationships between referenced instruction types are more similar. To reverse this, causing a higher value to correspond to similarity, the normalized instruction similarity may be subtracted from 1, such that high values (including 1) correspond to similarity and low values (including 0) correspond to difference between two sets of instructions.

FIG. 2C depicts exemplary process 232 for generating a normalized volume similarity. The system may first, at step 234, compute the CAD model volume of the reference component and the CAD model volume of the specified component. As mentioned above, this may entail computing a sum of the various volumes making up each component which in turn may be computed by analyzing the instructions contained within each text-based CAD file. As with generation of the normalized instruction similarity, information necessary to compute the volume may be found within the text-based CAD file of each of the reference component and specified component. This information may include, for example, the dimensions of one or more geometric shapes making up the CAD model of each component. In some implementations, the computed volume of each CAD model may be an approximated volume of the CAD model. For example, the system may model the threads of a screw as triangular or as consuming half of a particular thread volume, or may not include the thread features within an estimation of the volume of the CAD model.

With two computed volumes corresponding to the CAD model of each of the reference component and specified component, the system may compute the difference between the two volumes. Following computation of the volume difference, the system may take the absolute value of the volume difference value to ensure only positive values are considered. Next, at step 236, the system may normalize this difference by dividing the difference by a volume normalization factor. This volume normalization factor may be based on the CAD model volume of the referenced component and/or the specified component. For example, the volume normalization factor may be based on the higher volume value as between the CAD model volume of the referenced component and the CAD volume of the specified component. Alternatively or additionally, the volume normalization factor may be based on an average volume of the reference component model and the specified component model.

Thus, the normalized volume similarity corresponds to a volume difference between models of the two components and may be high when there is a significant difference in volume. To reverse this, causing a higher value to correspond to similarity, the normalized volume similarity may be subtracted from 1, such that high values (e.g. 1) correspond to similarity and low values (0) correspond to difference between two model volumes.

FIG. 2D depicts exemplary process 238 for generating a normalized surface or shape similarity. At step 240, the component identification system may compute a surface count for each surface type contained within a CAD model based on the number of surfaces of that type. Each of the reference component CAD model and specified component CAD model may be composed of several different types of surfaces. As with model volumes, the system may compute and/or determine these surface types based on the instructions within each text-based CAD file. For example, as shown in FIGS. 3E and 3F, surface types that CAD models such as model 360 or model 362 may contain include plane features and B-spline surfaces, for example corresponding to those the plane features of model 360 and the thread feature of model 362. Exemplary surface types may also include conical surface types, spherical surface types, toroidal surface types, Bezier surface types, and extrusion surface types. Additional surface types may include revolution-based surface types, offset-based surface types, and cylindrical surface types. The system may maintain a global list of surface types; if a surface type within a model fails to match any of the surface types on the global list, it may be counted as an unknown surface type. Similarly, if one of the specified or reference component CAD models includes a surface type not included in the other model, the surface type may be not be included in the surface difference computation. As mentioned above, the system may produce a surface count corresponding to the number of surfaces of each surface type. For example, within difference matrix 370 of FIG. 3G, rows labeled “part 1” and “part 2” include surface counts for one or more of the aforementioned surface types.

At step 242 of FIG. 2D, the system may next compute a surface difference for each surface type between the surface counts corresponding to the CAD model of the reference and specified components. For example, referring again to FIG. 3G, the system may compute the difference between the surface counts corresponding to “part 1” and “part 2” for each surface type listed in difference matrix 370. For example, “part 1” has a surface count of 63 for the plane surface type while “part 2” has a surface count of 88 for the plane surface type. The difference between these two surface counts is 25, representing the surface difference for the plane surface type. Following computation of the surface difference, the system may take the absolute value of the surface difference value to ensure only positive values are considered. Next, at step 244, the system may normalize the surface difference by dividing the surface difference by a surface normalization factor. This surface normalization factor may be based on the surface count of the reference component CAD model and/or the specified component CAD model. For example, the surface normalization factor may be based on the surface count with the higher value as between the CAD model of the referenced component and the CAD model of the specified component. Alternatively or additionally, the surface normalization factor may be based on an average surface count of the reference component model and the specified component model. Next, at step 246, the system may average the normalized surface difference corresponding to two or more of the surface types to produce a final normalized surface difference.

Thus, the normalized surface similarity corresponds to an average surface count difference for each surface type of each model of the two components and may be high when there is a significant difference in surface count. To reverse this, causing a higher value to correspond to similarity, the normalized surface similarity may be subtracted from 1, such that high values (e.g. 1) correspond to similarity and low values (0) correspond to difference between the average surface counts of the two models.

Returning to FIG. 2, once a one or more similarity values have been generated including normalized instruction similarity via process 222, a normalized volume similarity via process 232, and/or normalized surface similarity via process 238, the system may, at step 250, sum the three normalized similarity values to compute the similarity metric. In some implementations, this sum may be weighted to allow one normalized similarity value to factor more prominently into the final similarity metric than another normalized similarity value. For example, the system may compute a weighted sum based on the complexity of a component model. To compute a weighted sum the system may, for example, multiply an instruction weighting by the instruction similarity, a volume weighting by the volume similarity, and a surface weighting by the surface similarity.

In some implementations, if the instructions contained within the CAD files of one or both of the models of the reference component and the specified component are of a certain degree of complexity, the system may choose to deprioritize the weight applied to the instruction similarity. The system may determine whether the total number of instructions or keywords in one or both CAD files meet a threshold and/or whether a total number of one or more particular instruction types or keyword types meet a threshold. For example, the system may determine that a number of instruction or keyword types corresponding to generating a spline and/or curved feature meets a threshold, for example a threshold of 50, 100, 150, 200, 250, 300, 350, and/or 400 instructions, and may correspondingly reduce the weighting of the instruction similarity in the sum used to compute the similarity metric. This is because the splines and/or curved features may exponentially increase the number and complexity of instructions, a change that may not necessarily reflect significant geometrical changes that the similarity metric is designed to reflect. The volume weighting and/or surface weighting may be adjusted in a similar fashion to increase and/or decrease the impact of the volume similarity and/or surface similarity on the overall similarity metric.

In some implementations, the system may apply a particular set of weightings for situations in which one or both component models are deemed to have instructions indicating a low level of complexity, for example if the above threshold related to instructions corresponding to generating spline features is not met. In such a case, the system may apply an instruction weighting of 0.55, a volume weighting of 0.35, and a surface weighting of 0.1. Conversely, if one or both component models are deemed to have instructions indicating a sufficiently high level of complexity, for example if the above threshold related to instructions corresponding to generating spline features is met, the system may apply a different set of weightings, for example by reducing the instruction weighting. In such a case, the system may apply an instruction weighting of 0.1, a volume weighting of 0.5, and a surface weighting of 0.4. For example, if both components are sufficiently complex, the system may apply this combination of weightings. This reduction in the weighting of the instruction similarity may prevent the similarity metric from being over-sensitive to instruction complexity. That is, by reducing the weight given to instruction similarity, the system may ensure the similarity metric reflects the geometric similarity of the two components as revealed by similar instructions, volumes, and surface types or shapes, instead of a difference in the complexity of instructions used to form the two models. Each of the instruction weight, volume weight, and surface weighting may be at least 0, at least 0.1, at least 0.2, at least 0.3, at least 0.4, at least 0.5, at least 0.6, at least 0.7, at least 0.8, at least 0.9, at least 1, at most 1, at most 0.9, at most 0.8, at most 0.7, at most 0.6, at most 0.5, at most 0.4, at most 0.3, at most 0.2, and/or at most 0.1.

By normalizing each of the instruction similarity, volume similarity, and surface similarity, the system may ensure that each represents a unit value, varying from 0 to 1. In the implementation in which a sum of these three similarities is computed to generate the similarity metric, the instruction weighting, volume weighting, and surface weighting may be selected such that the weighted sum of the instruction similarity, volume similarity, and surface similarity may also vary from 0 to 1. In the above examples with these three weighting sets to 0.55, 0.35, and 0.1, or 0.1, 0.5, and 0.4, in both cases, the weightings sum to 1 ensuring that when each is multiplied by a normalized similarity value, the sum of those products will vary from 0 to 1.

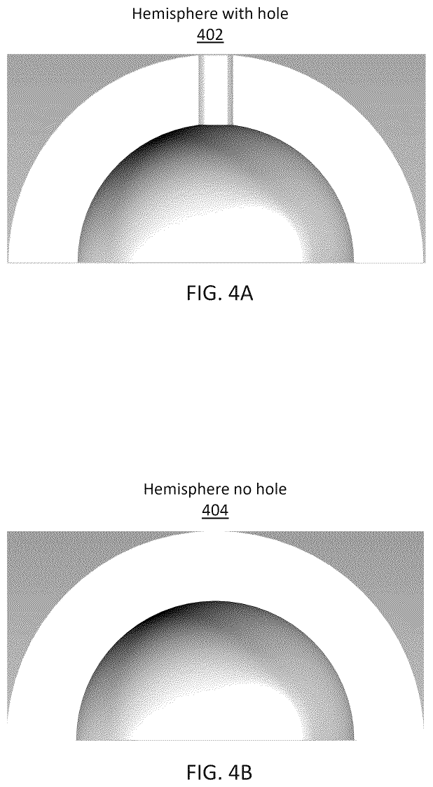

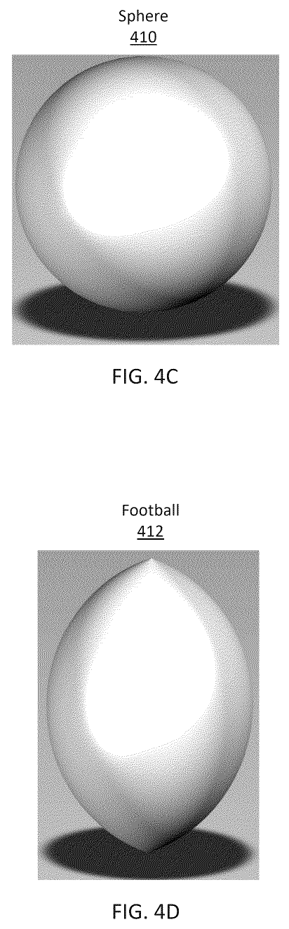

By computing a similarity metric that accounts for differences in model-generating instructions, model volume, and/or model surface types found in CAD files of reference and specified components, an exemplary component identification system may enable selection of one or more reference components similar to a specified component. For example, as depicted in FIGS. 4A and 4B, a hemisphere 402 with a hole feature may be compared to a hemisphere 404 without a hole feature. The absence of a hole feature, which may affect each of the model-generating instructions, model volume, and model surface types found in CAD files corresponding to models of each hemisphere component, resulted in a similarity metric of 0.18 or 18%. Similarly, as depicted in FIGS. 4C and 4D, a sphere 410 may be compared to a football 412. The differing form of CAD models of each geometric shape similarly resulted in a similarity metric, equaling 0.17 or 17%, indicating a significant geometrical difference.

In some implementations the similarity metric may be used directly by an exemplary component identification system to, at step 260, identify one or more reference components for use in the manufacturing process based on the similarity to the specified component. For example, the system may individually compute the similarity metric quantifying the similarity between each reference component and the specified component, and may identify one or more reference components based on the similarity metric of each reference component. In some implementations, the system may identify the one or more reference components with the highest similarity metrics. In other implementations, the system may identify one or more reference components based on a determination that the corresponding similarity metrics meet a similarity threshold. For example, the system may determine identify any reference components with a similarity metric equal to or greater than 0.95 or 95%.

In other implementations, the similarity metric may form a portion of the one or more inputs on which a prompt 252 to a generative AI language model 254 may be based. In some implementations, in addition to the similarity metric, language model prompt 252 may be based on textual user input or query 210 and/or on the one or more specified and/or reference component parameters 218 extracted from component parameter database 216. These inputs may combine to form an input to generative AI language model 254 which may be one or more artificial intelligence language model capable of understanding and tokenizing large datasets and providing insights in response to user queries. For example, language model 254 may be based on one or more commercially available language models such as OpenAI's GPT, Google's PaLM, and/or Meta's LLaMA. The system may form prompt 252 by combining a textual user input 210, for example “I want to find at least three replacements for component identification number SF004 that have certification ISO 7040,” one or more parameters 218, such as material and certification, of component SF004 and/or one or more reference components for which similarity metrics have been computed at step 220, and/or the one or more similarity metrics themselves. In processing this prompt, language model 254 and/or an associated tokenizing tool may tokenize the data including parameters and/or similarity metrics, use this tokenized data to form an output that identifies one or more reference components for use in the manufacturing process based on a similarity to a specified component.

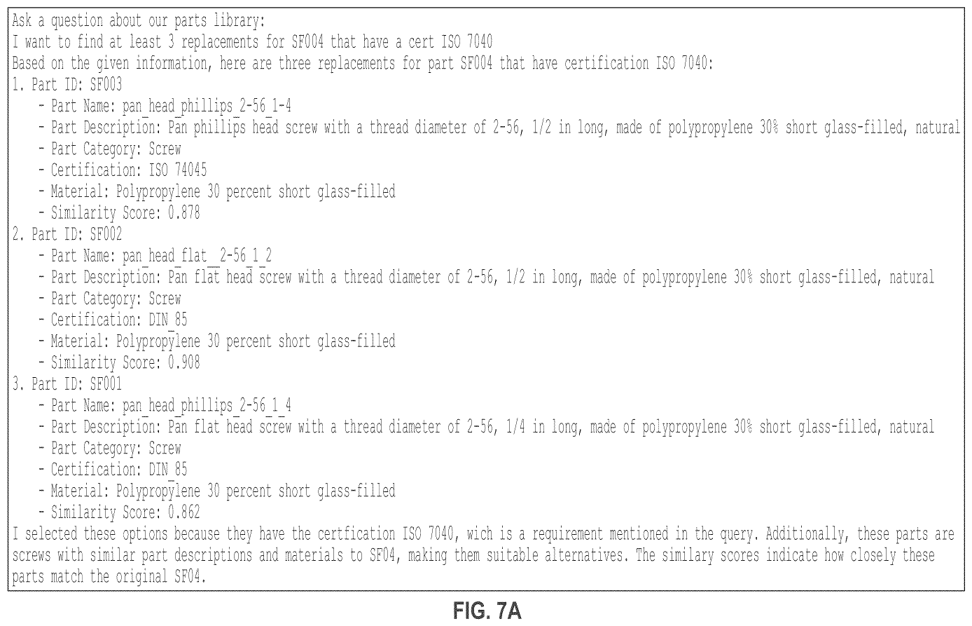

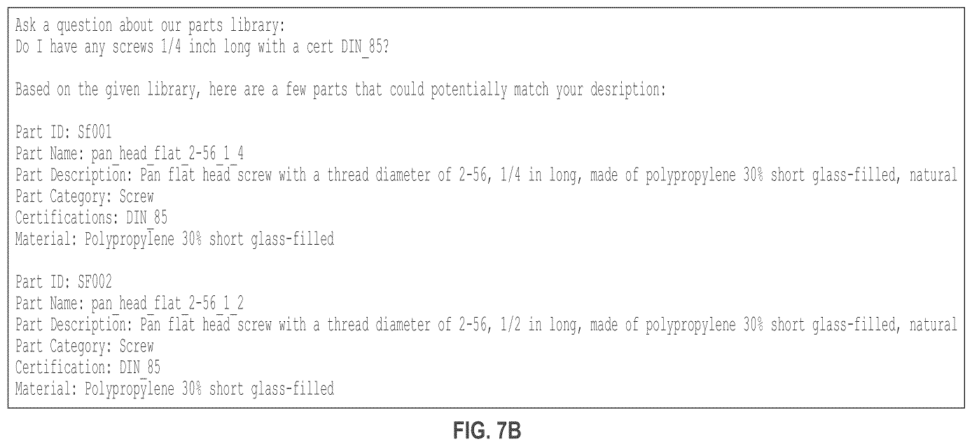

Language model 254 may take an exemplary prompt 252 formed by combining the aforementioned exemplary inputs and provide one or more reference components along with a natural language description of the output. As depicted in FIG. 7A, this language model output may take the form of a list of three reference components, including the component identification number, name, description, categories, certifications, material, and/or similarity metric. As described above, this result may be based on language model 254 locating the one or more highest similarity metrics of the similarity metrics that were provided as inputs, while considering the one or more parameters that were also provided as inputs, all with the objective of responding appropriately and accurately to the user's query. In the example of FIG. 7A, the query not only mentioned the user's desire to locate a similar part but to find one satisfying a particular certification. Thus, to form the output shown in FIG. 7A, language model 254 may have as an objective selecting components corresponding to the highest similarity metrics but to also ensure corresponding certification parameters match the specified certification.

As depicted in FIG. 7A, language model 254 may not only provide a natural language response explaining that the output represents three replacements that the model located, language model 254 may also provide a natural language explanation for the reasons for selecting the reference components that it did. For example, as shown in FIG. 7A, the model may explain that it selected the components it did because they satisfy the desired certification while also having similar descriptions and materials to the specified component. This inclusion of reasoning for selection of reference components may be particularly valuable in cases in which one or more parameters apart from similarity metric form a portion of user query 210 and/or prompt 252, allowing a user to understand why language model 254 and the component identification system more broadly identified the one or more reference components included in the chatbot output.

As described below, in some implementations, an exemplary component identification system may preprocess CAD file database 202 such that the similarity between each component and one or more other components has been calculated and stored in a database, for example component parameter database 216. This may enable the system to form prompt 252 based on, for example and in addition to user input 210, one or more similarity metrics or optionally all available similarity metrics, parameters of all components associated with these similarity metrics. This may allow language model 254 to tokenize and use as an input a much larger dataset, allowing for more finely tuned selection of reference components based on parameter data and/or similarity metric data. Language model 254 may employ, as discussed above, a selection process based on locating components with parameters and/or similarity metrics that are most similar to a specified component, and/or on selecting components with parameters and/or similarity metrics with normalized differences in relation to a specified component that meet a parameter and/or similarity threshold, for example 0.95 or 95%.

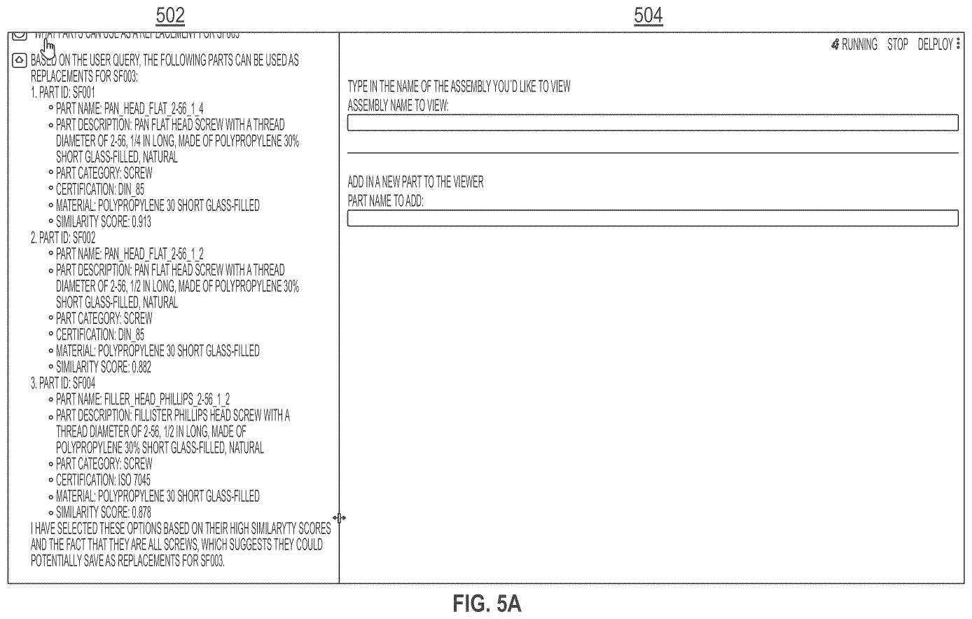

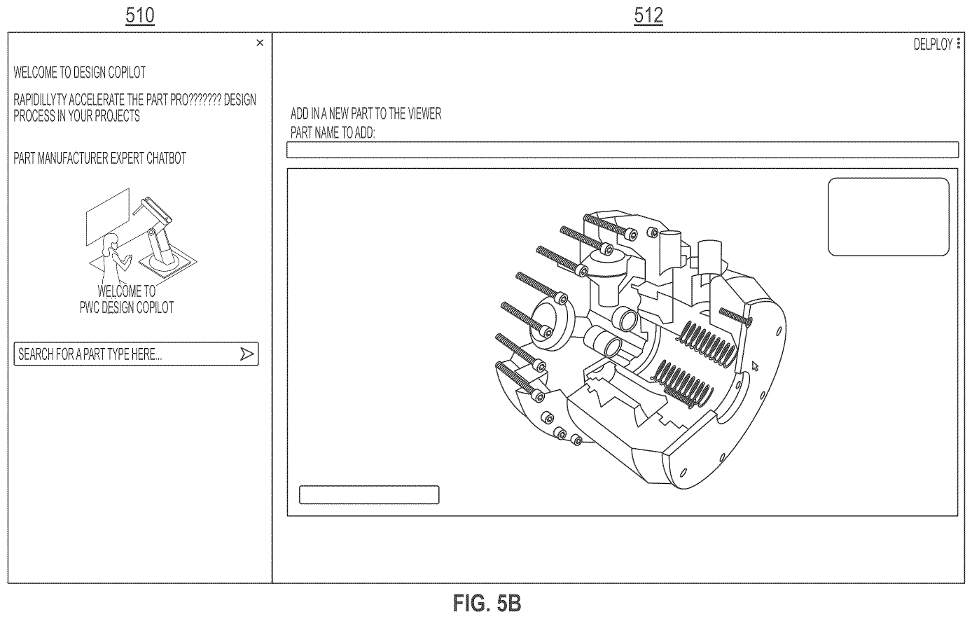

The chatbot interface or messaging module, allowing a user to interact with language model 254, may be form a portion of a GUI that is in turn included in a CAD program plugin as discussed above and/or designed to be used adjacent to and/or simultaneously with the CAD program. In some implementations, this GUI may be incorporated into a standalone application. An exemplary GUI of a standalone application and/or CAD plugin may include both a chatbot and a CAD model visualization module or portion as shown in FIGS. 5A and 5B. The exemplary GUI may include, as depicted in FIG. 5A, a chatbot portion 502 enabling a user to enter textual inputs or queries and a CAD model visualization portion 504 enabling a user to enter a component identification number and/or name to produce a visualization of the CAD model corresponding to the component, and enabling the user to manipulate the visualized CAD model.

Thus step 260 of process 200 involving identification of reference components for use in a manufacturing process based on similarity to a specified component may be accomplished in one or more of at least two ways. As described above, an exemplary system may identify one or more reference components based on the similarity metric associated with each reference component, and/or generative AI language model 254 may output one or more reference components via a chatbot interface based at least in part on the similarity metric of each reference component.

The component identification system may act further on the identified reference components with the objective of reducing component proliferation and/or to enable integration of existing components into newly designed assemblies and/or orders. In some implementations, at step 262, the system may import, using a CAD program plugin module, a CAD model of the one or more identified reference components. Similar to the process described above for providing the system a CAD model input for processing, the system, via the CAD program plugin may indicate one or more CAD models corresponding to the identified reference components for importation into a CAD program, for example into an assembly model within the CAD program. This may occur within a GUI of the plugin, for example allowing a user to approve for importation the CAD models of one or more reference components. Alternatively or additionally, importation of the one or more CAD models may be based on a user request sent via the chatbot interface. Alternatively or additionally, this importation may occur in an automatic manner following the identification of the one or more reference components.

In other implementations, at step 264, the system may display a CAD model of the one or more identified reference components on a GUI, for example a GUI of the CAD plugin and/or standalone application described above. For example, as shown in FIG. 5B, in addition to a chatbot portion 510, the GUI of a standalone application and/or CAD plugin may include a CAD model visualization portion 512. Visualization portion 512 may thus allow a user to visualize the one or more reference component models and/or specified component model, for example to make side-by-side comparisons between the reference and specified components. Such side-by-side comparisons between the reference and specified components may include overlay views in which a reference component is aligned to a specified component. Visualization portion 512 may allow a user to control the color and/or translucency of each component in turn allowing such an overlay to reveal the differences between the reference and specified components. Visualization portion 512 may additionally or alternatively allow visualization of an assembly along with one or more reference components to enable a user to understand the possible effects of switching to one or more reference components from the specified component.

Using visualization portion 512 instead of directly importing one or more reference component CAD models into an assembly within a CAD program may be advantageous in that it may allow, for example, a user to test various configurations and/or placements of a reference component model without impacting an assembly that may be used to specify the manufacture of a production system. Visualization portion 512 may allow a user to manipulate the CAD models of the one or more reference components, for example by panning or rotating the models, hiding one or more components, and/or by adjusting the zoom of the window of visualization portion 512. Visualization portion 512 may additionally or alternatively allow a user to apply one or more constraints to the one or more reference components, for example fixing the position and/or orientation of one or more faces, to precisely position the one or more reference component, for example by matching the one or more constraints applied to the specified component.

In other implementations, at step 266, the component identification system may remove the specified component and/or identified reference components from a database that may include information on one or more components, for example CAD file database 202 and/or component parameter database 216. In some implementations, the system may additionally or alternatively create a designation that indicates that the one or more reference components and/or specified component are similar to one another. By designating similarity and/or by removing altogether components deemed sufficiently similar or duplicative, component identification system may assist a manufacturing organization in reducing component proliferation. This reduction may result from engineers and/or procurement coordinators finding a single component instead of multiple duplicative ones for use in forming a new assembly and/or component order. This reduction may additionally or alternatively result by allowing an engineer and/or procurement coordinator to search a database such as component parameter database 216 for an indication of similarity, thus increasing the likelihood that an existing component may be used instead of creating or requesting the creation of a new component.

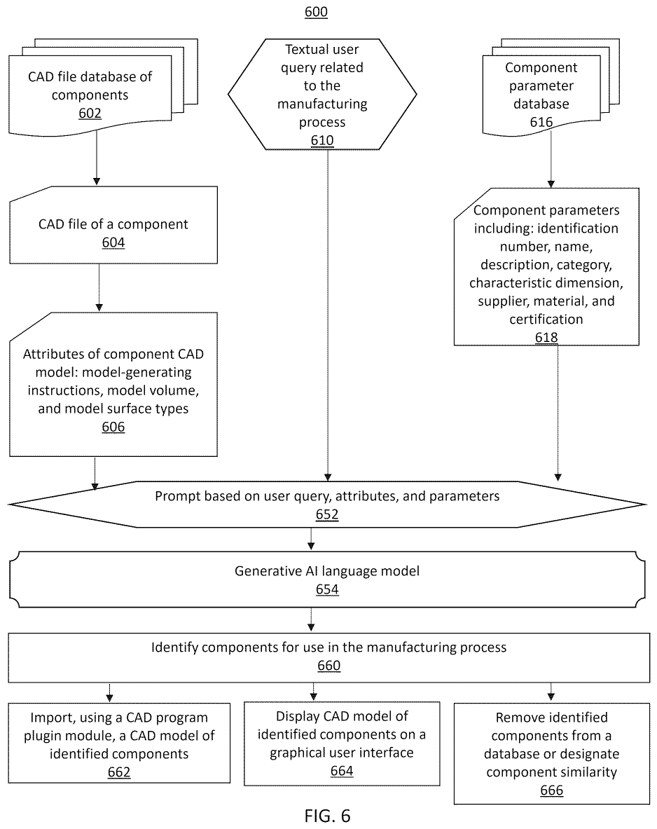

In some implementations, as depicted by process 600 of FIG. 6, an exemplary component identification system may generate a prompt 652 to provide to a generative AI language model 654 that may be based at least on a textual user query 610 that relates to the manufacturing process and/or on component parameters 618 that may be extracted from component parameter database 616 as described above. Additionally or alternatively, prompt 652 may be based on component attributes 606, for example model-generating instructions, model volume, and/or model surface types extracted from a text-based CAD file of a component 604 that itself may have been identified and extracted from CAD file database 602 including one or more components. User query 610 may thus include, instead of a precise component specification as in process 200, one or more component attributes and/or parameters with a request for the system to provide components similar to or matching these attributes and/or parameters. In this way, prompt 252 of FIG. 2A may be based on different inputs than prompt 652 of FIG. 6. For example, prompt 252 may be based on component parameter information, a textual user input, and/or a similarity metric as discussed above. Prompt 652 may also be based on component parameter information and/or a textual user input, although instead of a similarity metric, prompt 652 may additionally or alternatively be based directly on attributes of a component CAD model, for example one or more model-generating instructions.

CAD file 604 may have been identified and extracted, as discussed above based on relevance to this user query 610 and/or to one or more parameters extracted from component parameter database 616. For example, if user query 610 relates to a search for a fastener of a particular length and/or including a particular certification, one or more components and associated CAD files may be identified using component parameter database 616 as being of similar length and/or having a similar certification. As mentioned above, inclusion within component parameter database 616 of relationship information such as parameters related to one specified by the user in query 610 may enable the system and/or the generative AI language model 654 to locate parameters to use to form a prompt in instances in which an exact match may not be readily locatable.

As described above, a user may interact with language model 654 using a chatbot which may form a portion of a GUI located within a CAD plugin of a CAD program and/or may form a portion of GUI of a standalone application. The language model may tokenize data provided in the prompt and output, at step 660, a response identifying one or more components for use in a manufacturing process and responsive to user query 610. Because user query 610 of process 600 may not include a specification of a particular component, instead of basing parameters 618 and/or attributes 606 in part on a specified component, parameters 618 and/or attributes 618 may be based instead on parameters and/or attributes mentioned in the user query. For example, as depicted in FIG. 7B, user query 610 may take the form “do I have any screws ¼ inch long with a certification of DIN 85?” In response, language model 654 may search through tokenized data including attribute data and/or parameter data, for example focusing on parameter data corresponding to characteristic dimension, description, and/or certification. As discussed above, language model 654 may employ a selection process based on locating components with attributes and/or parameters that are most similar to a user query, and/or on selecting components with attributes and/or parameters with normalized differences in relation to the user query that meet an attribute and/or parameter threshold, for example 0.95 or 95%. As shown in FIG. 7B, the output may comprise an identification of two components, including the component identification number, name, description, categories, certifications, and/or material. The output provided by language model 654 may include reasoning, as mentioned above, for example indicating which of the one or more parameters listed served to narrow down a more inclusive list of components and serve as the basis for identifying the components included in the model's output.

As in process 200 of FIG. 2, process 600 may entail the system acting on the identification of components occurring at step 660 to, for example, import a CAD model of the one or more identified components into a CAD program and/or an existing assembly using, for example, a CAD program plugin module at step 662. In some implementations, the system may display a CAD model of the one or more identified components within a CAD model visualization module or portion as shown in FIGS. 5A and 5B. As described above, this may allow a user to visualize and/or manipulate a component for example in the context of an assembly into which it may be installed. In other implementations, at step 666, an exemplary system may remove one or more components from a component database such as CAD file database 602 and/or component parameter database 616. Additionally or alternatively, the system may designate one or more components as similar to one another with one or more of the aforementioned component databases. In both cases, the system's actions may reduce the likelihood that the employees of a manufacturing organization may create new components instead of using existing components, thereby contributing to the reduction of the proliferation of components within the organization.

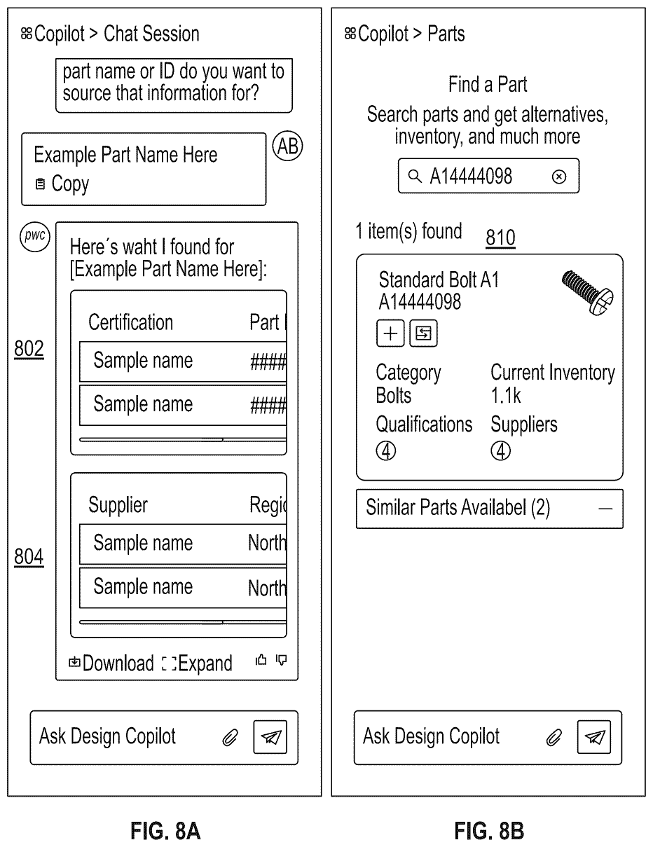

In addition to more open-ended questions that relate to similarity to specified components and/or to specified component attributes and/or parameters, in some implementations, an exemplary component identification system may return more information in response to more targeted user queries. For example, as depicted in FIG. 8A, the system may return, in response to a user input of a component identification number and/or name, information related to one or more certifications, suppliers, and/or storage locations. This result may be returned by a generative AI language model in response to the user entering a query into a chatbot, as discussed above. Additionally or alternatively, this may be a result of a direct search using a GUI of the system, located with a CAD program plugin module or a standalone application, allowing the user to provide the system a textual input. The language model may analyze a user-created table to produce this result, for example a table including data related to a component's minimum order quality, lead time, and/or quantity in storage. In this way, the system may assist users find quickly find specific components, useful when an organization has a large inventory of components.

As depicted in FIG. 8B, the system may return, in response to a user input of a component identification number and/or name, information related to the category, number of stored components located in inventory, one or more qualifications (e.g. relating to performance and/or safety testing), and/or one or more suppliers approved to produce and/or supply the part. In this manner, component identification system may act as a search tool that may allow a user to quickly understand the parameters and/or attributes of various components. Sources of data that the system may search to provide an a search result include at least the CAD file database and/or the metadata included within such a database, and/or the component parameter database as previously discussed.

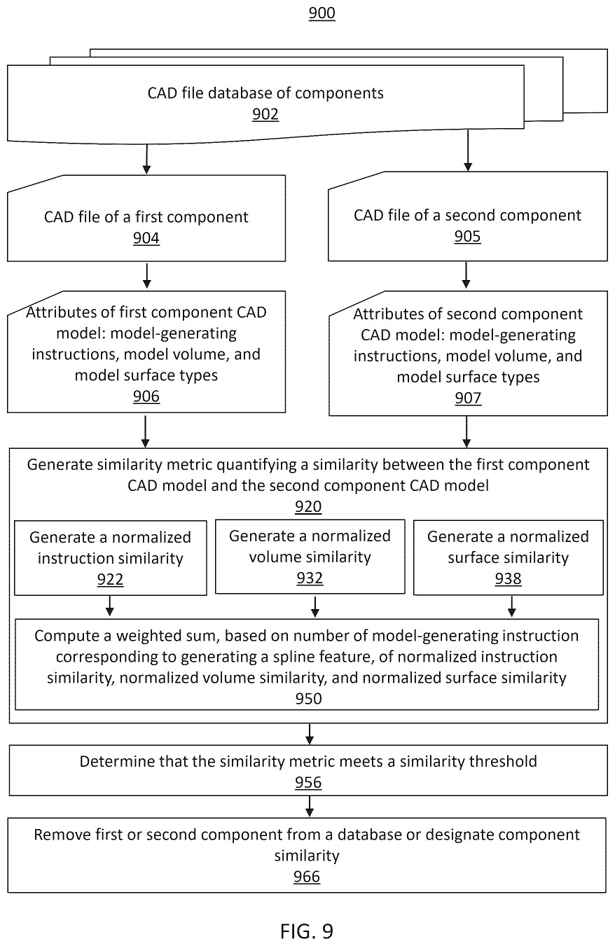

In some implementations, as depicted by process 900 of FIG. 9, an exemplary component identification system may be used to preprocess a CAD file database 902 including one or more components to generate similarity metrics for one or more of the components. With a user input specifying a particular component to use as a basis to locate similar components, the system may instead compare the CAD models of two components to one another, in place of a comparison between one component and a specified component. To preprocess CAD file database 902, the system may begin with a CAD file 904 of a first component and a CAD file 905 of a second component, extracting attributes 906 of the first component CAD model and attributes 907 of the second component CAD model. As mentioned above, each set of attributes may include one or more of model-generating instructions, model volume, and model surface type located within each text-based CAD file, for example each STEP file.

The system may generate a similarity metric quantifying the similarity between the first component CAD model and the second component CAD model at step 920. This may mirror step 220 in process 200 of FIG. 2, with the exception that neither of the two components being compared was necessarily specified by the user via a user input. However, since in some implementations the specified component was itself a reference component, with attributes extracted from, for example, CAD file database 202, once two CAD files for comparison have been identified and/or extracted, the generation of a similarity metric at steps 220 and 920 may be appreciably similar. For example, as described in the context of step 220, at step 920, a normalized instruction similarity may be generated at step 922 following the process laid out in FIG. 2B, a normalized volume similarity may be generated at step 932 following the process laid out in FIG. 2C, and/or a normalized surface similarity may be generated at step 938 following the process laid out in FIG. 2D.

Following generation of one or more of the aforementioned similarity values, a sum of the similarities may be computed at step 950 to generate the similarity metric. As at step 250, this sum may be weighted to allow one normalized similarity value to factor more prominently into the final similarity metric than another normalized similarity value. For example, the system may compute a weighted sum based on the complexity of a component model. To compute a weighted sum the system may, for example, multiply an instruction weighting by the instruction similarity, a volume weighting by the volume similarity, and a surface weighting by the surface similarity. As described above, the instruction similarity weighting may be adjust based on the complexity of the instructions of one or more of the first component and second component, which in turn may be based on the total number of instructions and/or on the total number of instructions of a certain type, for example instruction or keyword types corresponding to generating a spline feature. For example, the number of instruction or keyword types corresponding to generating a spline feature may be compared to a threshold, for example 200 instructions to determine whether the threshold is met and whether the instruction weighting should be reduced by a certain amount. The volume weighting and/or surface weighting may be adjusted in a similar fashion to increase and/or decrease the impact of the volume similarity and/or surface similarity on the overall similarity metric. By normalizing each of the instruction similarity, volume similarity, and surface similarity, the system may ensure that each represents a unit value, varying from 0 to 1. In the implementation in which a sum of these three similarities is computed to generate the similarity metric, the instruction weighting, volume weighting, and surface weighting may be selected such that the weighted sum of the instruction similarity, volume similarity, and surface similarity may also vary from 0 to 1.

At step 956 of process 900, the system may compare the overall similarity metric to a similarity threshold to determine whether the similarity metric meets a threshold, for example 0.95 or 95%. If the system determines that the similarity metric meets the similarity threshold, at step 966, the system may remove one or both of the first component and second component from CAD file database 902 and/or additional component databases such as a component parameter database. Additionally or alternatively, the system may designate one or both of the first component and second component as similar to one another within CAD file database 902 and/or additional component databases such as a component parameter database. In both cases, the system's actions may reduce the likelihood that the employees of a manufacturing organization may create new components instead of using existing components, thereby contributing to the reduction of the proliferation of components within the organization.

To preprocess CAD file database 902, generating for each component a similarity metric corresponding to one or more other components, the system may proceed systematically, selecting a different component as the second component, for example until a similarity metric has been computed quantifying the similarity between the first component and every other component within CAD file database 902. Once the system reaches this point, a different component may be used in place of the first component and a similarity metric may be computed quantifying the similarity between this component and, for example, every other component within CAD file database 902. This process may be repeated until every component within CAD file database 902 has been represented in the above process as the first component and compared to every other component within CAD file database 902. Alternatively, the system may focus on only a category of components, for example only on fasteners, or only on components stored at a particular storage location. Preprocessing CAD file database 902 in such a manner may enable an exemplary component identification system to more readily identify one or more components with sufficient similarity to a component specified by a user and/or to component attributes and/or parameters provided by a user in a user prompt.

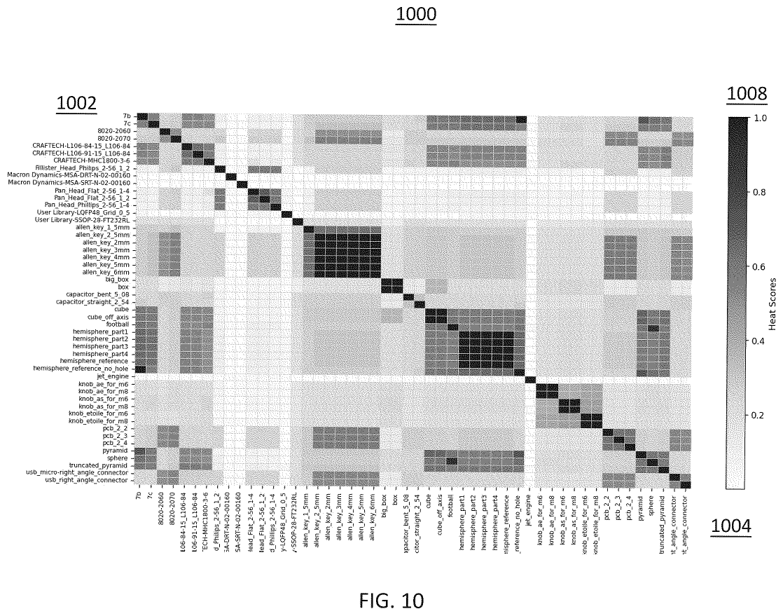

With a CAD file database preprocessed to include the similarity metric between each of one or more components of the CAD file database and one or more other components contained within the database, an exemplary component identification system may produce summary infographics such as heatmap 1000 shown in FIG. 10. Heatmap 1000 may represent this preprocessed data, namely the similarity metric between a set of one or more components of the CAD file database and each of the other components in the set. This means, for example, that components forming vertical axis 1002 of heatmap 1000 may be identical to the components forming horizontal axis 1004. Similarity metric values may be normalized to vary between 0 and 1 as discussed above and may be represented within the plot of heatmap 1000 as a color gradient 1008 that varies in color between 0 and 1. This may produce, as shown in FIG. 10, a heatmap with datapoints of varying color depending on the similarity between the component listed as the horizontal axis value and the component listed as the vertical axis value. Due to the horizontal and vertical axes including the same set of components heatmap 1000 may be diagonally symmetric, with values on the diagonal representing a comparison of the same component and thus maximal similarity. Such a heatmap may be used by an engineer and/or procurement coordinator of an organization to quickly visualize and/or address any unknown similarities or redundancies within a component dataset provided to the system. The system may determine display one or more components that are sufficiently similar, for example meeting a similarity threshold, on a CAD model visualization portion or module for further investigation.

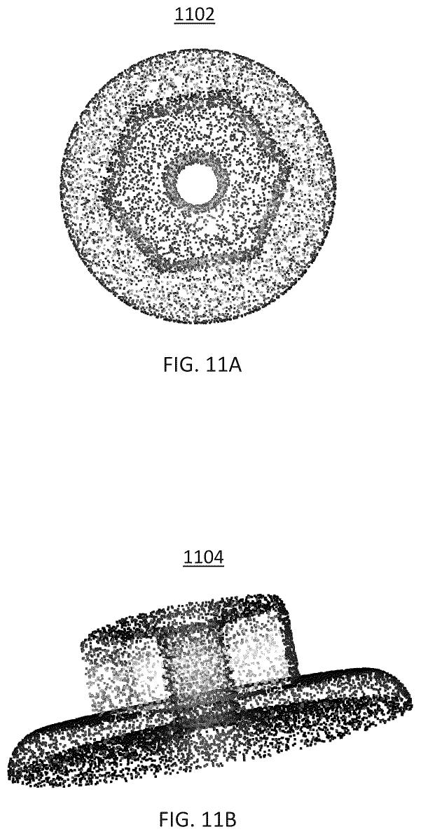

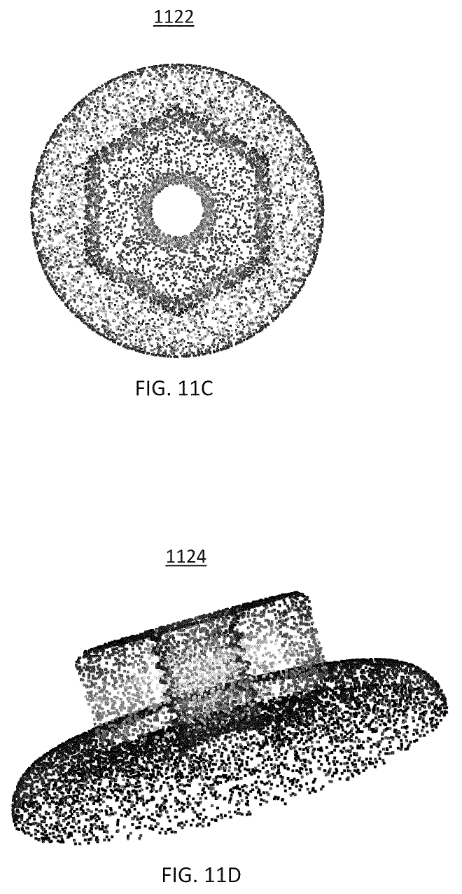

FIGS. 11A and 11B depict an alternative manner by which an exemplary component identification system may compute a similarity between two components. For example, the system may generate, based on surfaces contained within CAD files of two components, two sets of points or point clouds that may represent the surfaces of the two component CAD models. Representing two components as point clouds may allow a system to make a comparison in three-dimensional space by measuring the distance and/or relationship between the two point clouds. Such a computation may take into account differences in component geometry and may enable control over the fidelity of the metric by increasing and/or decreasing the number of points making up the point cloud.

One or more methods may be used to compute the distance and/or relationship between sets of points following an initial alignment, for example based on the coordinate systems present in the CAD files of the two components. For example, the system may compute the Pearson's R value between two sets of points or two point clouds, for example by computing the R value between the x-coordinates of the two point clouds, the R value between the y-coordinates of the two point clouds, and/or the R value between the z-coordinates of the two point clouds. The R value may vary from 0 to 1 and may correspond the degree of alignment between coordinates of each axis of each of the two point clouds, in turn indicating how similar the point clouds are.

Additional or alternative methods that may be used to generate metrics indicating the similarity between the two point clouds may include computing multiple point to plane normalizations or the distance between a point in one point cloud and a plane surface in the other point cloud generated by first selecting a point then forming a plane based on nearby points within the point cloud. The selection of two points, one from each point cloud, may be based on a nearest neighbor approach, for example by comparing the Euclidean distance between a point in one point cloud and all points in the other point cloud and selecting the point in the other point cloud corresponding to the lowest Euclidean distance. Each distance may be normalized by a normal distance from the plane to the point. A set of distances may be computed and may be, for example, averaged to indicate a representative distance or similarity between the two point clouds.

Alternative or additional computation methods may include computing multiple point to point normalizations in which the Euclidean distance between two points, one in each point cloud, with points optionally selected again based on a nearest neighbor approach. This distance may be normalized or scaled based on the magnitude of distance values, for example small distances may be increased by a fixed scalar such that difference may be more apparent. Here again, a set of distances may be computed and may be, for example, averaged to indicate a representative distance or similarity between the two point clouds.

One or more of these alignment and/or distance measurement techniques may be used to generate metrics indicating similarity between a component CAD model and a specified component CAD model and/or between two component CAD models. These metrics may be used in addition to or as alternative to generation of a similarity metric as discussed above in the contexts of process 200 and process 900 of FIGS. 2 and 9 respectively. For example, FIGS. 11A and 11B include views 1102 and 1104 of a point cloud of a first component while FIGS. 11C and 11D include views 1122 and 1124 of a point cloud of a second component that differs from the first component based on the size of the center hole feature and corresponding thread. In addition to a similarity metric computation on the CAD models of these two components, the system may use one or more of the aforementioned techniques to evaluate the alignment and/or distance between points of each point cloud, providing an alternative technique to evaluate similarity between two component models.

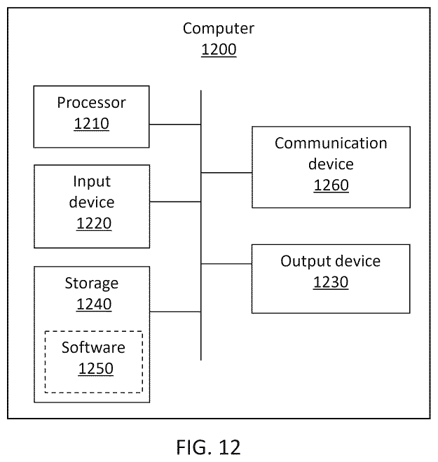

In one or more examples, the disclosed systems and methods utilize or may include a computer system. FIG. 12 depicts an exemplary computing system according to one or more examples of the disclosure. Computer 1200 can be a host computer connected to a network. Computer 1200 can be a client computer or a server. As shown in FIG. 12, computer 1200 can be any suitable type of microprocessor-based device, such as a personal computer, workstation, server, or handheld computing device, such as a phone or tablet. The computer can include, for example, one or more of processor 1210, input device 1220, output device 1230, storage 1240, and communication device 1260. Input device 1220 and output device 1230 can correspond to those described above and can either be connectable or integrated with the computer.

Input device 1220 can be any suitable device that provides input, such as a touch screen or monitor, keyboard, mouse, or voice-recognition device. Output device 1230 can be any suitable device that provides an output, such as a touch screen, monitor, printer, disk drive, or speaker.

Storage 1240 can be any suitable device that provides storage, such as an electrical, magnetic, or optical memory, including a random-access memory (RAM), cache, hard drive, CD-ROM drive, tape drive, or removable storage disk. Communication device 1260 can include any suitable device capable of transmitting and receiving signals over a network, such as a network interface chip or card. The components of the computer can be connected in any suitable manner, such as via a physical bus or wirelessly. Storage 1240 can be a non-transitory computer-readable storage medium comprising one or more programs, which, when executed by one or more processors, such as processor 1210, cause the one or more processors to execute methods described herein.

Software 1250, which can be stored in storage 1240 and executed by processor 1210, can include, for example, the programming that embodies the functionality of the present disclosure (e.g., as embodied in the systems, computers, servers, and/or devices as described above). In one or more examples, software 1250 can include a combination of servers such as application servers and database servers.

Software 1250 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 1240, that can contain or store programming for use by or in connection with an instruction execution system, apparatus, or device.

Software 1250 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 1200 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 1200 can implement any operating system suitable for operating on the network. Software 1250 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

### EXEMPLARY EMBODIMENTS

Exemplary embodiments of the systems and methods for component identification described herein include:
Embodiment 1. A method for identifying components for use in a manufacturing process, the method comprising:
receiving a plurality of computer-aided design (CAD) files of components;
receiving a user input specifying a component related to the manufacturing process;
generating a similarity metric quantifying a similarity between a model of a reference component and a model of the specified component, wherein the similarity is based on:
at least one first attribute of a reference component model stored within a CAD file, of the plurality of CAD files of components, wherein the at least one first attribute is selected from a group consisting of: a set of model-generating instructions, a model volume, and a set of model surface types; and
at least one second attribute of a specified component model stored within a CAD file of the specified component, wherein the at least one second attribute is selected from a group consisting of: a set of model-generating instructions, a model volume, and a set of model surface types; and
identifying, based on the similarity metric, one or more reference components for use in the manufacturing process.
Embodiment 2. The method of embodiment 1, wherein identifying the one or more reference components further comprises at least one of:
identifying a reference component corresponding to a similarity metric that is higher than the similarity metric corresponding to one or more other reference components; or
identifying a reference component corresponding to a similarity metric that meets a similarity threshold.
Embodiment 3. The method of embodiment 1, wherein generating the similarity metric comprises generating at least one of:
an instruction similarity based on a squared distance between a numerical representation of the set of model-generating instructions for the reference component model and a numerical representation of the set of model-generating instructions for the specified component model;
a volume similarity based on a difference between the model volume of the reference component and the model volume of the specified component; or
a surface similarity based on a difference between a numerical representation of the set of model surface types of the reference component and a numerical representation of the set of model surface types of the specified component.
Embodiment 4. The method of embodiment 3, wherein generating each of the numerical representations of the sets of model-generating instructions comprises:
computing, for each instruction type in a set of model-generating instructions, a reference count based on a number of references made by the instruction type to one or more other instruction types in the set; and
storing each reference count in a tensor wherein a row index of the tensor and a column index of the tensor each comprise two or more instruction types in the set.
Embodiment 5. The method of embodiment 4, wherein generating the instruction similarity comprises:
computing a squared distance between a tensor corresponding to the reference component and a tensor corresponding to the specified component; and
normalizing the squared distance by dividing the squared distance by an instruction normalization factor based on a magnitude of the tensor corresponding to the reference component or a magnitude of the tensor corresponding to the specified component.
Embodiment 6. The method of embodiment 3, wherein generating the volume similarity comprises:
normalizing the difference between the model volume of the reference component and the model volume of the specified component by dividing the difference by a volume normalization factor;
wherein the volume normalization factor is based on the model volume of the reference component or the model volume of the specified component.
Embodiment 7. The method of embodiment 3, wherein generating each of the numerical representations of the sets of model surface types comprises computing, for each surface type in a set of model surface types, a surface count based on a number of surfaces of the surface type in a model.
Embodiment 8. The method of embodiment 7, wherein generating the surface similarity comprises, for each surface type:
computing a surface difference between a surface count of the reference component model and a surface count of the specified component model; and
normalizing the surface difference by dividing the surface difference by a surface normalization factor based on the surface count of the reference component model or the surface count of the specified component model.
Embodiment 9. The method of embodiment 8, wherein generating the surface similarity further comprises averaging two or more normalized surface differences, wherein each normalized surface difference corresponds to a surface type.
Embodiment 10. The method of embodiment 3, wherein computing the similarity metric further comprises computing a sum of the instruction similarity, the volume similarity, and the surface similarity.
Embodiment 11. The method of embodiment 10, wherein computing the sum of the instruction similarity comprises:
computing the sum of an instruction weighting multiplied by the instruction similarity, a volume weighting multiplied by the volume similarity, and a surface weighting multiplied by the surface similarity;
wherein at least one of the instruction weighting, the volume weighting, or the surface weighting is based on a degree of complexity of at least one of the reference component model or the specified component model.
Embodiment 12. The method of embodiment 11, wherein the degree of complexity is based on a number of model-generating instructions corresponding to generating a spline feature.
Embodiment 13. The method of embodiment 1, wherein receiving the user input comprises receiving a textual input specifying a component related to the manufacturing process.
Embodiment 14. The method of embodiment 13, wherein:
receiving the textual input comprises receiving a user query specifying the component related to the manufacturing process; and
identifying the one or more reference components further comprises:
retrieving, from a database, one or more parameters of a reference component corresponding to the user query;
generating and providing a prompt to a generative AI language model, wherein the prompt is generated based on the user query, the one or more parameters, and the similarity metric; and
receiving, from the generative AI language model and in response to the input prompt, an output comprising an identification of the one or more reference components for use in the manufacturing process.
Embodiment 15. The method of embodiment 14, wherein the one or more parameters of the reference component comprise at least one of: an identification number, a name, a description, a category, a characteristic dimension, a supplier, a storage location, a material, or a certification.
Embodiment 16. The method of embodiment 14, wherein the output further comprises one or more reasons for identifying the one or more reference components.
Embodiment 17. The method of embodiment 1, wherein receiving the user input comprises receiving, from a CAD program plugin module, an indication of a CAD model.
Embodiment 18. The method of embodiment 1, the method further comprising importing into a CAD program, using a CAD program plugin module, a CAD model of at least one of the identified one or more reference components.
Embodiment 19. The method of embodiment 1, the method further comprising displaying a graphical user interface, wherein the graphical user interface comprises at least one of:
a messaging module configured to allow a user to send and receive messages; or
a visualization module configured to allow a user to view a CAD model.
Embodiment 20. The method of embodiment 19, the method further comprising:
importing, using the graphical user interface, a CAD model of at least one of the identified one or more reference components;
wherein the visualization module is configured to allow a user to view the CAD model of at least one of the identified one or more reference components.
Embodiment 21. The method of embodiment 20, the method further comprising:
importing, using the graphical user interface, a CAD model of the specified component;
wherein the visualization module is configured to allow a user to view the CAD model of the specified component while simultaneously viewing the at least one of the identified one or more reference components.
Embodiment 22. The method of embodiment 1, the method further comprising at least one of:
removing, from one or more databases comprising one or more components, at least one component selected from a group comprising: the specified component and the identified one or more reference components; or
designating, within the one or more databases, an indication of similarity for at least one component selected from a group comprising: the specified component and the identified one or more reference components.
Embodiment 23. The method of embodiment 22, wherein designating the indication of similarity comprises recording, within the one or more databases, the similarity metric for at least one component selected from a group comprising: the specified component and the identified one or more reference components.
Embodiment 24. The method of embodiment 1, wherein at least one CAD file, selected from a group consisting of the plurality of CAD files of components and the CAD file of the specified component, comprises a standard for the exchange of product-model data (STEP) file.
Embodiment 25. A system for identifying components for use in a manufacturing process, the system comprising one or more processors and memory storing instructions that, when executed by the one or more processors, cause the system to:
receive a plurality of computer-aided design (CAD) files of components;
receive a user input specifying a component related to the manufacturing process;
generate a similarity metric quantifying a similarity between a model of a reference component and a model of the specified component, wherein the similarity is based on:
   at least one first attribute of a reference component model stored within a CAD file, of the plurality of CAD files of components, wherein the at least one first attribute is selected from a group consisting of: a set of model-generating instructions, a model volume, and a set of model surface types; and
   at least one second attribute of a specified component model stored within a CAD file of the specified component, wherein the at least one second attribute is selected from a group consisting of: a set of model-generating instructions, a model volume, and a set of model surface types; and
identify, based on the similarity metric, one or more reference components for use in the manufacturing process.
Embodiment 26. A non-transitory computer readable storage medium storing instructions for identifying components for use in a manufacturing process, wherein the instructions, when executed by one or more processors of an electronic device, cause the device to:
receive a plurality of computer-aided design (CAD) files of components;
receive a user input specifying a component related to the manufacturing process;
generate a similarity metric quantifying a similarity between a model of a reference component and a model of the specified component, wherein the similarity is based on:
   at least one first attribute of a reference component model stored within a CAD file, of the plurality of CAD files of components, wherein the at least one first attribute is selected from a group consisting of: a set of model-generating instructions, a model volume, and a set of model surface types; and
   at least one second attribute of a specified component model stored within a CAD file of the specified component, wherein the at least one second attribute is selected from a group consisting of: a set of model-generating instructions, a model volume, and a set of model surface types; and
identify, based on the similarity metric, one or more reference components for use in the manufacturing process.
Embodiment 27. A method for identifying components for use in a manufacturing process, the method comprising:
receiving a plurality of computer-aided design (CAD) files of components;
receiving a textual user query related to the manufacturing process;
retrieving, from a CAD file of the plurality of CAD files of components, at least one attribute corresponding to the user query and selected from a group consisting of: a set of model-generating instructions, a model volume, and a set of model surface types;
generating and providing a prompt to a generative AI language model, wherein the prompt is generated based on the user query and the at least one attribute; and
receiving, from the generative AI language model and in response to the input prompt, an output comprising an identification of the one or more components for use in the manufacturing process.
Embodiment 28. The method of embodiment 27, wherein generating and providing the prompt to the generative AI language model further comprises:
retrieving, from a database, one or more parameters of a component corresponding to the user query;
wherein the prompt is generated based additionally on the one or more parameters; and
wherein the one or more parameters comprise at least one of: an identification number, a name, a description, a category, a characteristic dimension, a supplier, a storage location, a material, or a certification.
Embodiment 29. The method of embodiment 27, wherein the output further comprises one or more reasons for identifying the one or more components.
Embodiment 30. The method of embodiment 27, the method further comprising importing into a CAD program, using a CAD program plugin module, a CAD model of at least one of the identified one or more components.
Embodiment 31. The method of embodiment 27, the method further comprising displaying a graphical user interface, wherein the graphical user interface comprises at least one of:
a messaging module configured to allow a user to send and receive messages; or
a visualization module configured to allow a user to view a CAD model.
Embodiment 32. The method of embodiment 31, the method further comprising:
importing, using the graphical user interface, a CAD model of at least one of the identified one or more components;
wherein the visualization module is configured to allow a user to view the CAD model of at least one of the identified one or more components.
Embodiment 33. The method of embodiment 27, the method further comprising at least one of:
removing, from one or more databases comprising one or more components, at least one of the identified one or more components; or
designating, within the one or more databases, an indication of similarity for at least one of the identified one or more components.
Embodiment 34. The method of embodiment 33, wherein designating the indication of similarity comprises recording, within the one or more databases, the similarity metric for at least one of the identified one or more components.
Embodiment 35. The method of embodiment 27, wherein at least one of the plurality of CAD files of components comprises a standard for the exchange of product-model data (STEP) file.
Embodiment 36. A system for identifying components for use in a manufacturing process, the system comprising one or more processors and memory storing instructions that, when executed by the one or more processors, cause the system to:
receive a plurality of computer-aided design (CAD) files of components;
receive a textual user query related to the manufacturing process;
retrieve, from a CAD file of the plurality of CAD files of components, at least one attribute corresponding to the user query and selected from a group consisting of: a set of model-generating instructions, a model volume, and a set of model surface types;
generate and provide a prompt to a generative AI language model, wherein the prompt is generated based on the user query and the at least one attribute; and
receive, from the generative AI language model and in response to the input prompt, an output comprising an identification of the one or more components for use in the manufacturing process.
Embodiment 37. A non-transitory computer readable storage medium storing instructions for identifying components for use in a manufacturing process, wherein the instructions, when executed by one or more processors of an electronic device, cause the device to:
receive a plurality of computer-aided design (CAD) files of components;
receive a textual user query related to the manufacturing process;
retrieve, from a CAD file of the plurality of CAD files of components, at least one attribute corresponding to the user query and selected from a group consisting of: a set of model-generating instructions, a model volume, and a set of model surface types;
generate and provide a prompt to a generative AI language model, wherein the prompt is generated based on the user query and the at least one attribute; and
receive, from the generative AI language model and in response to the input prompt, an output comprising an identification of the one or more components for use in the manufacturing process.
Embodiment 38. A method for identifying two or more similar components, the method comprising:
receiving a plurality of computer-aided design (CAD) files of components,
generating a similarity metric quantifying a similarity between a model of a first component and a model of a second component, wherein the similarity is based on:
   at least one first attribute of a first component model stored within a CAD file, of the plurality of CAD files of components, wherein the at least one first attribute is selected from a group consisting of: a set of model-generating instructions, a model volume, and a set of model surface types; and
   at least one second attribute of a second component model stored within a CAD file of the second component, wherein the at least one second attribute is selected from a group consisting of: a set of model-generating instructions, a model volume, and a set of model surface types; and
determining that the similarity metric meets a similarity threshold.
Embodiment 39. The method of embodiment 38, wherein generating the similarity metric comprises generating at least one of:
an instruction similarity based on a squared distance between a numerical representation of the set of model-generating instructions for the first component model and a numerical representation of the set of model-generating instructions for the second component model;
a volume similarity based on a difference between the model volume of the first component and the model volume of the second component; or
a surface similarity based on a difference between a numerical representation of the set of model surface types of the first component and a numerical representation of the set of model surface types of the second component.
Embodiment 40. The method of embodiment 39, wherein generating each of the numerical representations of the sets of model-generating instructions comprises:
computing, for each instruction type in a set of model-generating instructions, a reference count based on a number of references made by the instruction type to one or more other instruction types in the set; and
storing each reference count in a tensor wherein a row index of the tensor and a column index of the tensor each comprise two or more instruction types in the set.
Embodiment 41. The method of claim 40, wherein generating the instruction similarity comprises:
computing a squared distance between a tensor corresponding to the first component and a tensor corresponding to the second component; and
normalizing the squared distance by dividing the squared distance by an instruction normalization factor based on a magnitude of the tensor corresponding to the first component or a magnitude of the tensor corresponding to the second component.
Embodiment 42. The method of embodiment 39, wherein generating the volume similarity comprises:
normalizing the difference between the model volume of the first component and the model volume of the second component by dividing the difference by a volume normalization factor;
wherein the volume normalization factor is based on the model volume of the first component or the model volume of the second component.
Embodiment 43. The method of embodiment 39, wherein generating each of the numerical representations of the sets of model surface types comprises computing, for each surface type in a set of model surface types, a surface count based on a number of surfaces of the surface type in a model.
Embodiment 44. The method of embodiment 43, wherein generating the surface similarity comprises, for each surface type:
computing a surface difference between a surface count of the first component model and a surface count of the second component model; and
normalizing the surface difference by dividing the surface difference by a surface normalization factor based on the surface count of the first component model or the surface count of the second component model.
Embodiment 45. The method of embodiment 44, wherein generating the surface similarity further comprises averaging two or more normalized surface differences, wherein each normalized surface difference corresponds to a surface type.
Embodiment 46. The method of claim 39, wherein computing the similarity metric further comprises computing a sum of the instruction similarity, the volume similarity, and the surface similarity.
Embodiment 47. The method of embodiment 46, wherein computing the sum of the instruction similarity comprises:
computing the sum of an instruction weighting multiplied by the instruction similarity, a volume weighting multiplied by the volume similarity, and a surface weighting multiplied by the surface similarity;
wherein at least one of the instruction weighting, the volume weighting, or the surface weighting is based on a degree of complexity of at least one of the first component model or the second component model.
Embodiment 48. The method of embodiment 47, wherein the degree of complexity is based on a number of model-generating instructions corresponding to generating a spline feature.
Embodiment 49. The method of embodiment 38, the method further comprising at least one of:
removing, from one or more databases comprising one or more components, at least one of the first component or the second component; or
designating, within the one or more databases, an indication of similarity for at least one of the first component or the second component.
Embodiment 50. The method of embodiment 49, wherein designating the indication of similarity comprises recording, within the one or more databases, the similarity metric for at least one of the first component or the second component.
Embodiment 51. The method of embodiment 38, wherein at least one of the plurality of CAD files of components comprises a standard for the exchange of product-model data (STEP) file.
Embodiment 52. A system for identifying two or more similar components, the system comprising one or more processors and memory storing instructions that, when executed by the one or more processors, cause the system to:
receive a plurality of computer-aided design (CAD) files of components;
generate a similarity metric quantifying a similarity between a model of a first component and a model of a second component, wherein the similarity is based on:
   at least one first attribute of a first component model stored within a CAD file, of the plurality of CAD files of components, wherein the at least one first attribute is selected from a group consisting of: a set of model-generating instructions, a model volume, and a set of model surface types; and
   at least one second attribute of a second component model stored within a CAD file of the second component, wherein the at least one second attribute is selected from a group consisting of: a set of model-generating instructions, a model volume, and a set of model surface types; and
determine that the similarity metric meets a similarity threshold.
Embodiment 53. A non-transitory computer readable storage medium storing instructions for identifying two or more similar components, wherein the instructions, when executed by one or more processors of an electronic device, cause the device to:
receive a plurality of computer-aided design (CAD) files of components;
generate a similarity metric quantifying a similarity between a model of a first component and a model of a second component, wherein the similarity is based on:
   at least one first attribute of a first component model stored within a CAD file, of the plurality of CAD files of components, wherein the at least one first attribute is selected from a group consisting of: a set of model-generating instructions, a model volume, and a set of model surface types; and
   at least one second attribute of a second component model stored within a CAD file of the second component, wherein the at least one second attribute is selected from a group consisting of: a set of model-generating instructions, a model volume, and a set of model surface types; and
determine that the similarity metric meets a similarity threshold.

1. A method for identifying components for use in a manufacturing process, the method comprising:
receiving a plurality of computer-aided design (CAD) files of components;
receiving a user input specifying a component related to the manufacturing process;
generating a similarity metric quantifying a similarity between a model of a reference component and a model of the specified component, wherein the similarity is based on:
at least one first attribute of a reference component model stored within a CAD file, of the plurality of CAD files of components, wherein the at least one first attribute is selected from a group consisting of: a set of model-generating instructions, a model volume, and a set of model surface types; and
at least one second attribute of a specified component model stored within a CAD file of the specified component, wherein the at least one second attribute is selected from a group consisting of: a set of model-generating instructions, a model volume, and a set of model surface types; and
identifying, based on the similarity metric, one or more reference components for use in the manufacturing process.

2. The method of claim 1, wherein identifying the one or more reference components further comprises at least one of:
identifying a reference component corresponding to a similarity metric that is higher than the similarity metric corresponding to one or more other reference components; or
identifying a reference component corresponding to a similarity metric that meets a similarity threshold.

3. The method of claim 1, wherein generating the similarity metric comprises generating at least one of:
an instruction similarity based on a squared distance between a numerical representation of the set of model-generating instructions for the reference component model and a numerical representation of the set of model-generating instructions for the specified component model;
a volume similarity based on a difference between the model volume of the reference component and the model volume of the specified component; or
a surface similarity based on a difference between a numerical representation of the set of model surface types of the reference component and a numerical representation of the set of model surface types of the specified component.

4. The method of claim 3, wherein generating each of the numerical representations of the sets of model-generating instructions comprises:
computing, for each instruction type in a set of model-generating instructions, a reference count based on a number of references made by the instruction type to one or more other instruction types in the set; and
storing each reference count in a tensor wherein a row index of the tensor and a column index of the tensor each comprise two or more instruction types in the set.

5. The method of claim 4, wherein generating the instruction similarity comprises:
computing a squared distance between a tensor corresponding to the reference component and a tensor corresponding to the specified component; and
normalizing the squared distance by dividing the squared distance by an instruction normalization factor based on a magnitude of the tensor corresponding to the reference component or a magnitude of the tensor corresponding to the specified component.

6. The method of claim 3, wherein generating the volume similarity comprises:
normalizing the difference between the model volume of the reference component and the model volume of the specified component by dividing the difference by a volume normalization factor;
wherein the volume normalization factor is based on the model volume of the reference component or the model volume of the specified component.

7. The method of claim 3, wherein generating each of the numerical representations of the sets of model surface types comprises computing, for each surface type in a set of model surface types, a surface count based on a number of surfaces of the surface type in a model.

8. The method of claim 7, wherein generating the surface similarity comprises, for each surface type:
computing a surface difference between a surface count of the reference component model and a surface count of the specified component model; and
normalizing the surface difference by dividing the surface difference by a surface normalization factor based on the surface count of the reference component model or the surface count of the specified component model.

9. The method of claim 8, wherein generating the surface similarity further comprises averaging two or more normalized surface differences, wherein each normalized surface difference corresponds to a surface type.

10. The method of claim 3, wherein computing the similarity metric further comprises computing a sum of the instruction similarity, the volume similarity, and the surface similarity.

11. The method of claim 10, wherein computing the sum of the instruction similarity comprises:
computing the sum of an instruction weighting multiplied by the instruction similarity, a volume weighting multiplied by the volume similarity, and a surface weighting multiplied by the surface similarity;
wherein at least one of the instruction weighting, the volume weighting, or the surface weighting is based on a degree of complexity of at least one of the reference component model or the specified component model.

12. The method of claim 11, wherein the degree of complexity is based on a number of model-generating instructions corresponding to generating a spline feature.

13. The method of claim 1, wherein receiving the user input comprises receiving a textual input specifying a component related to the manufacturing process.

14. The method of claim 13, wherein:
receiving the textual input comprises receiving a user query specifying the component related to the manufacturing process; and
identifying the one or more reference components further comprises:
retrieving, from a database, one or more parameters of a reference component corresponding to the user query;
generating and providing a prompt to a generative AI language model, wherein the prompt is generated based on the user query, the one or more parameters, and the similarity metric; and
receiving, from the generative AI language model and in response to the input prompt, an output comprising an identification of the one or more reference components for use in the manufacturing process.

15. The method of claim 14, wherein the one or more parameters of the reference component comprise at least one of: an identification number, a name, a description, a category, a characteristic dimension, a supplier, a storage location, a material, or a certification.

16. The method of claim 14, wherein the output further comprises one or more reasons for identifying the one or more reference components.

17. The method of claim 1, wherein receiving the user input comprises receiving, from a CAD program plugin module, an indication of a CAD model.

18. The method of claim 1, the method further comprising importing into a CAD program, using a CAD program plugin module, a CAD model of at least one of the identified one or more reference components.

19. The method of claim 1, the method further comprising displaying a graphical user interface, wherein the graphical user interface comprises at least one of:
a messaging module configured to allow a user to send and receive messages; or
a visualization module configured to allow a user to view a CAD model.

20. The method of claim 19, the method further comprising:
importing, using the graphical user interface, a CAD model of at least one of the identified one or more reference components;
wherein the visualization module is configured to allow a user to view the CAD model of at least one of the identified one or more reference components.

21. The method of claim 20, the method further comprising:
importing, using the graphical user interface, a CAD model of the specified component;
wherein the visualization module is configured to allow a user to view the CAD model of the specified component while simultaneously viewing the at least one of the identified one or more reference components.

22. The method of claim 1, the method further comprising at least one of:
removing, from one or more databases comprising one or more components, at least one component selected from a group comprising: the specified component and the identified one or more reference components; or
designating, within the one or more databases, an indication of similarity for at least one component selected from a group comprising: the specified component and the identified one or more reference components.

23. The method of claim 22, wherein designating the indication of similarity comprises recording, within the one or more databases, the similarity metric for at least one component selected from a group comprising: the specified component and the identified one or more reference components.

24. The method of claim 1, wherein at least one CAD file, selected from a group consisting of the plurality of CAD files of components and the CAD file of the specified component, comprises a standard for the exchange of product-model data (STEP) file.

25. A system for identifying components for use in a manufacturing process, the system comprising one or more processors and memory storing instructions that, when executed by the one or more processors, cause the system to:
receive a plurality of computer-aided design (CAD) files of components;
receive a user input specifying a component related to the manufacturing process;
generate a similarity metric quantifying a similarity between a model of a reference component and a model of the specified component, wherein the similarity is based on:
at least one first attribute of a reference component model stored within a CAD file, of the plurality of CAD files of components, wherein the at least one first attribute is selected from a group consisting of: a set of model-generating instructions, a model volume, and a set of model surface types; and
at least one second attribute of a specified component model stored within a CAD file of the specified component, wherein the at least one second attribute is selected from a group consisting of: a set of model-generating instructions, a model volume, and a set of model surface types; and
identify, based on the similarity metric, one or more reference components for use in the manufacturing process.

26. A non-transitory computer readable storage medium storing instructions for identifying components for use in a manufacturing process, wherein the instructions, when executed by one or more processors of an electronic device, cause the device to:
receive a plurality of computer-aided design (CAD) files of components;
receive a user input specifying a component related to the manufacturing process;
generate a similarity metric quantifying a similarity between a model of a reference component and a model of the specified component, wherein the similarity is based on:
at least one first attribute of a reference component model stored within a CAD file, of the plurality of CAD files of components, wherein the at least one first attribute is selected from a group consisting of: a set of model-generating instructions, a model volume, and a set of model surface types; and
at least one second attribute of a specified component model stored within a CAD file of the specified component, wherein the at least one second attribute is selected from a group consisting of: a set of model-generating instructions, a model volume, and a set of model surface types; and
identify, based on the similarity metric, one or more reference components for use in the manufacturing process.
